(19) United States
(12) Patent Application Publication
(10) Pub. No.: US 2025/0303704 A1
(43) Pub. Date: Oct. 2, 2025

(54) LIQUID DISCHARGE DEVICE AND LIQUID DISCHARGE HEAD

(71) Applicant: SEIKO EPSON CORPORATION, Tokyo (JP)

(72) Inventor: Osamu SHINKAWA, Chino (JP)

(21) Appl. No.: 19/090,671

(22) Filed: Mar. 26, 2025

(30) Foreign Application Priority Data
Mar. 28, 2024 (JP) 2024-052707

(51) Int. Cl. B41J 2/045; B41J 2/14

(52) U.S. Cl. CPC B41J 2/04571; B41J 2/04581; B41J 2/14233; B41J 2002/14266

(57) ABSTRACT

An inkjet printer includes a drive signal generation unit configured to generate a drive signal, a discharge section including a nozzle, a piezoelectric element driven by the drive signal, and a cavity configured to discharge ink from the nozzle according to the driving of the piezoelectric element, a first inspection signal generation circuit configured to receive input of a residual vibration signal generated according to vibration remaining in the discharge section after the piezoelectric element is driven and generate a pseudo residual vibration signal corresponding to the residual vibration signal, an inspection unit configured to determine a state of the discharge section based on the pseudo residual vibration signal, and a first switching circuit configured to switch whether to supply the residual vibration signal to the first inspection signal generation circuit.

The present application is based on, and claims priority from JP Application Serial Number 2024-052707, filed Mar. 28, 2024, the disclosure of which is hereby incorporated by reference herein in its entirety.

### BACKGROUND

### 1. Technical Field

The present disclosure relates to a liquid discharge device and a liquid discharge head.

### 2. Related Art

A liquid discharge device such as an inkjet printer drives, in each of a plurality of unit periods defined by a latch signal, a discharge section provided in a liquid discharge head to thereby discharge liquid such as ink filled in the discharge section to form an image on a medium. However, in the liquid discharge device of this type, a discharge abnormality in which the liquid cannot be normally discharged from the discharge section sometimes occurs. Accordingly, a technique of inspecting a discharge state in the discharge section has been proposed. For example, JP-A-2020-044771 discloses a technique of inspecting a discharge state of a discharge section based on a detection signal indicating vibration remaining in the discharge section after the discharge section is driven by a drive signal.

JP-A-2020-044771 is an example of the related art.

However, according to the related art, when the discharge state of the discharge section is inspected, in a unit period as a cycle for driving the discharge section, in order to execute both of the driving of the discharge section by the drive signal and the detection of the vibration remaining in the driven discharge section, it is necessary to set the unit period to a sufficiently long time length.

### SUMMARY

According to an aspect of the present disclosure, there is provided a liquid discharge device including: a drive signal generation section configured to generate a drive signal; a discharge section including a nozzle, a piezoelectric element driven by the drive signal, and a pressure chamber configured to discharge liquid from the nozzle according to the driving of the piezoelectric element; a signal generation section configured to receive input of a residual vibration signal generated according to vibration remaining in the discharge section after the piezoelectric element is driven and generate a pseudo residual vibration signal corresponding to the residual vibration signal; a determination section configured to determine a state of the discharge section based on the pseudo residual vibration signal; and a switching section configured to switch whether to supply the residual vibration signal to the signal generation section.

According to another aspect of the present disclosure, there is provided a liquid discharge head including: a discharge section including a nozzle, a piezoelectric element driven by a drive signal, and a pressure chamber configured to discharge liquid from the nozzle according to the driving of the piezoelectric element; a signal generation section configured to receive input of a residual vibration signal generated according to vibration remaining in the discharge section after the piezoelectric element is driven and generate a pseudo residual vibration signal corresponding to the residual vibration signal as a signal for determining a state of the discharge section; and a switching section configured to switch whether to supply the residual vibration signal to the signal generation section.

### BRIEF DESCRIPTION OF THE DRAWINGS

FIG. 1 is a block diagram illustrating an example of a configuration of an inkjet printer according to an embodiment of the present disclosure.

FIG. 2 is a perspective view illustrating an example of schematic internal structure of the inkjet printer.

FIG. 3 is a cross-sectional view illustrating an example of structure of a discharge section.

FIG. 4 is a diagram illustrating an ink discharge operation in the discharge section.

FIG. 5 is a plan view illustrating an example of arrangement of nozzles in a head unit.

FIG. 6 is a block diagram illustrating an example of a configuration of the head unit.

FIG. 7 is a block diagram illustrating an example of a configuration of a detection circuit.

FIG. 8 is a circuit diagram illustrating an example of a configuration of a first selection circuit.

FIG. 9 is a circuit diagram illustrating an example of a configuration of a first inspection signal generation circuit.

FIG. 10 is a circuit diagram illustrating an example of a configuration of a second inspection signal generation circuit.

FIG. 11 is a diagram illustrating characteristics of a first filter circuit.

FIG. 12 is a diagram illustrating a simulation result of the first filter circuit.

FIG. 13 is a diagram illustrating an operation of a low-pass filter circuit at the time when a first input signal has been switched from a detection signal to a first reference potential.

FIG. 14 is a diagram illustrating effects of a first switching circuit and the low-pass filter circuit.

FIG. 15 is a timing chart illustrating an example of an operation of the inkjet printer in a unit period.

FIG. 16 is a diagram illustrating an example of a first inspection signal generated by the first inspection signal generation circuit.

FIG. 17 is a diagram illustrating an example of a second inspection signal generated by the second inspection signal generation circuit.

FIG. 18 is a block diagram illustrating an example of a configuration of a detection circuit according to a first modification.

FIG. 19 is a circuit diagram illustrating an example of a configuration of a third filter circuit according to the first modification.

### DESCRIPTION OF EMBODIMENTS

Modes for implementing the present disclosure are explained below with reference to the drawings. However, in the figures, dimensions and scales of sections are differentiated from actual ones as appropriate. Embodiments explained below are preferred specific examples of the present disclosure. Therefore, various technically preferable limitations are applied to the embodiments. However, the scope of the present disclosure is not limited to these embodiments unless there is particularly a description to the effect that the present disclosure is limited in the following explanation.

### 1. Embodiment

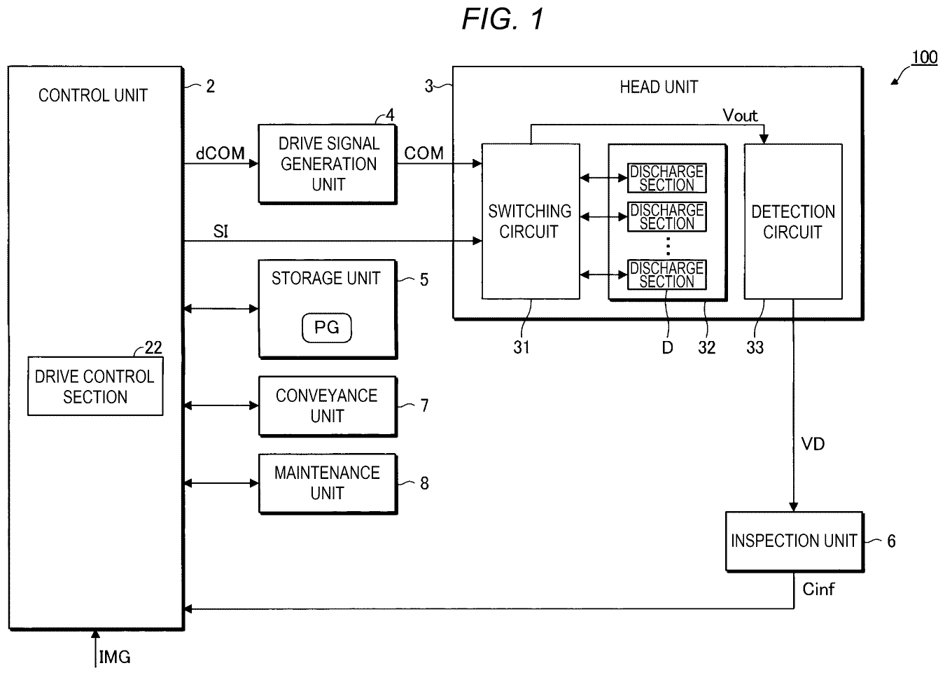

In the present embodiment, a liquid discharge device is explained exemplifying an inkjet printer that discharges ink to form an image on recording paper. In the present embodiment, the ink is an example of “liquid”. First, a configuration of an inkjet printer 1 according to the embodiment is explained with reference to FIG. 1.

FIG. 1 is a block diagram illustrating an example of the configuration of the inkjet printer 1 according to an embodiment of the present disclosure.

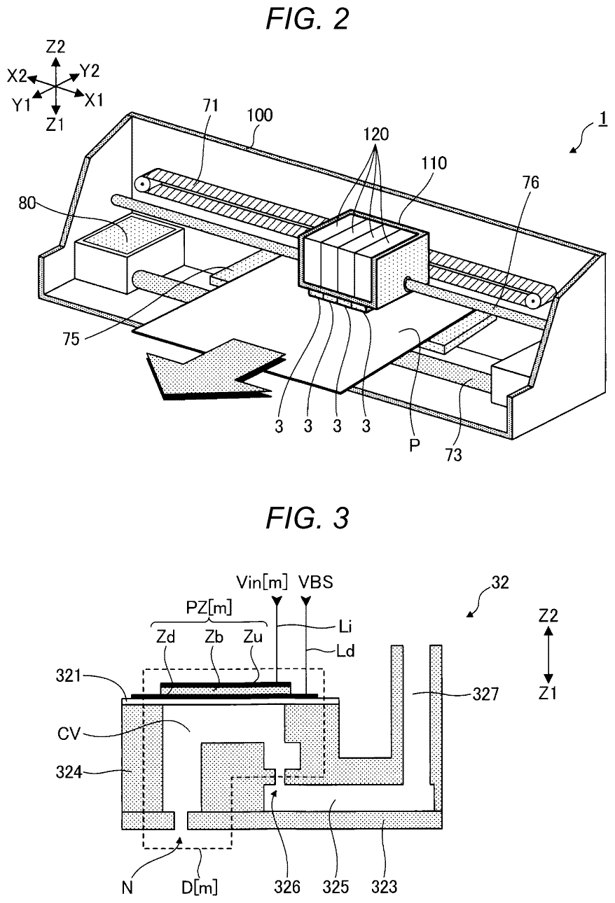

Print data IMG indicating an image that the inkjet printer 1 should form is supplied to the inkjet printer 1 from a host computer such as a personal computer or a digital camera. The inkjet printer 1 executes print processing of forming the image indicated by the print data IMG supplied from the host computer on a medium. In the present embodiment, recording paper P illustrated in FIG. 2 explained below is assumed as the medium.

The inkjet printer 1 includes a control unit 2 that controls sections of the inkjet printer 1, a head unit 3 in which a discharge section D that discharges ink is provided, and a drive signal generation unit 4 that generates a drive signal COM for driving the discharge section D. The inkjet printer 1 includes a storage unit 5 that stores various kinds of information such as the print data IMG and a control program PG of the inkjet printer 1 and an inspection unit 6 that determines a state of the discharge section D. Further, the inkjet printer 1 includes a conveyance unit 7 for changing a relative position of the recording paper P with respect to the head unit 3 and a maintenance unit 8 that executes maintenance processing of maintaining the discharge section D provided in the head unit 3. The head unit 3 is an example of a “liquid discharge head”, the drive signal generation unit 4 is an example of a “drive signal generation section” and the inspection unit 6 is an example of a “determination section”.

Here, in the present embodiment, it is assumed that the head unit 3 and the drive signal generation unit 4 correspond to each other and the head unit 3 and the inspection unit 6 correspond to each other. For example, the inkjet printer 1 may include a plurality of head units 3, a plurality of drive signal generation units 4 corresponding to the plurality of head units 3 in a one-to-one relation, and a plurality of inspection units 6 corresponding to the plurality of head units 3 in a one-to-one relation. Alternatively, the inkjet printer 1 may include one head unit 3, one drive signal generation unit 4 corresponding to the one head unit 3, and one inspection unit 6 corresponding to the one head unit 3. In the embodiment, it is assumed that the inkjet printer 1 includes four head units 3, four drive signal generation units 4 corresponding to the four head units 3 in a one-to-one relation, and four inspection units 5 corresponding to the four head units 3 in a one-to-one relation. However, in the following explanation, for convenience of explanation, the explanation focuses on one head unit 3 among the four head units 3, one drive signal generation unit 4 provided to correspond to the one head unit 3 among the four drive signal generation units 4, and one inspection unit 6 provided to correspond to the one head unit 3 among the four inspection units 5.

The control unit 2 includes one or a plurality of CPUs (Central Processing Units). The control unit 2 may include a programmable logic device such as a field-programmable gate array (FPGA) instead of or in addition to the CPU. The control unit 2 functions as a drive control section 22 by executing the control program PG stored in the storage unit 5.

The drive control section 22 generates a signal for controlling operations of the sections of the inkjet printer 1 such print signal SI and a waveform designation signal dCOM. The waveform designation signal dCOM is a digital signal for defining a waveform of the drive signal COM. The drive signal COM is an analog signal for driving the discharge section D. The print signal SI is a digital signal for designating a type of an operation of the discharge section D. Specifically, the print signal SI is a signal for designating a type of an operation of the discharge section D by designating whether to supply the drive signal COM to the discharge section D.

When the print processing is executed, for example, the drive control section 22 controls the head unit 3 and the conveyance unit 7 to thereby execute the print processing of printing an image indicated by the print data IMG on the recording paper P. Specifically, when the print processing is executed, the drive control section 22 generates a signal for controlling the head unit 3 such as the print signal SI based on the print data IMG. When the print processing is executed, the drive control section 22 generates a signal for controlling the drive signal generation unit 4 such as the waveform designation signal dCOM. When the print processing is executed, the drive control section 22 generates a signal for controlling the conveyance unit 7. Accordingly, in the print processing, the drive control section 22 adjusts the presence or absence of discharge of the ink from the discharge section D[m], a discharge amount of the ink, discharge timing of the ink, and the like while controlling the conveyance unit 7 to change the relative position of the recording paper P with respect to the head unit 3. As explained above, the drive control section 22 controls the sections of the inkjet printer 1 such that an image corresponding to the print data IMG is formed on the recording paper P.

The drive signal generation unit 4 includes, for example, a digital analog converter (DAC) and generates the drive signal COM based on the waveform designation signal dCOM supplied from the drive control section 22. For example, the drive signal generation unit 4 generates the drive signal COM including a waveform defined by the waveform designation signal dCOM. The drive signal generation unit 4 outputs the drive signal COM generated based on the waveform designation signal dCOM to a switching circuit 31 provided in the head unit 3.

The storage unit 5 includes one or both of a volatile memory such as a random access memory (RAM) and a nonvolatile memory such as a read-only memory (ROM), an electrically erasable programmable read-only memory (EEPROM), or a programmable ROM (PROM). The storage unit 5 may be provided in the control unit 2.

The head unit 3 includes the switching circuit 31, a recording head 32, and a detection circuit 33.

The recording head 32 includes M discharge sections D. The value M is a natural number equal to or greater than 1. In the following explanation, an m-th discharge section D among the M discharge sections D provided in the recording head 32 is sometimes referred to as discharge section D[m]. Here, the variable m is a natural number satisfying “1≤m≤M”. In the following explanation, when an element, a signal, or the like of the inkjet printer 1 corresponds to the discharge section D[m] among the M discharge sections D, a suffix[m] is sometimes added to reference signs for representing the element, the signal, or the like.

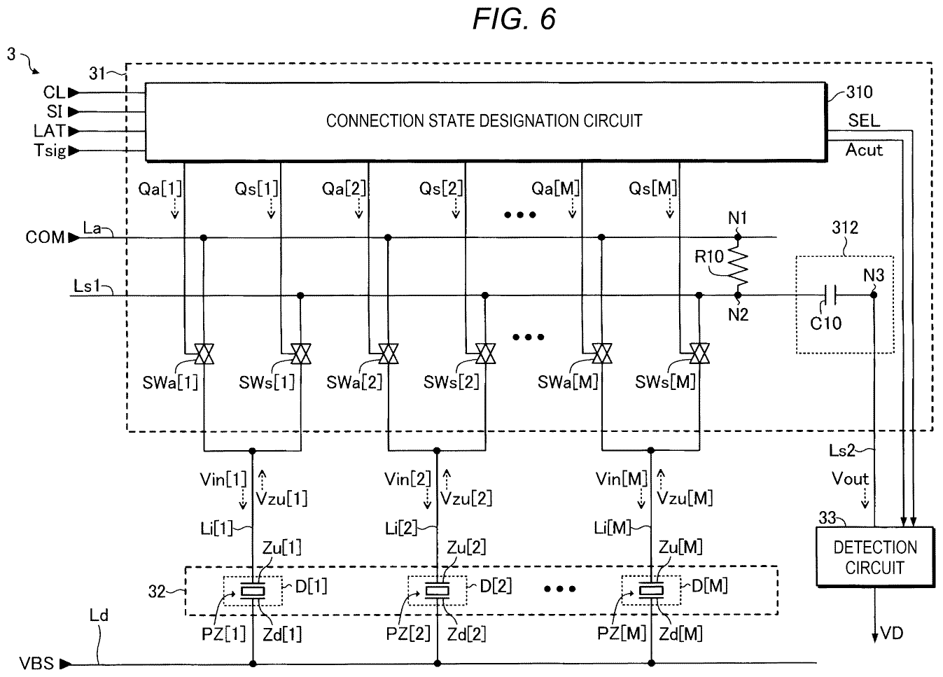

The switching circuit 31 switches, based on the print signal SI, whether to supply the drive signal COM to the discharge section D[m]. In the following explanation, as illustrated in FIG. 6 and the like referred to below, the drive signal COM supplied to the discharge section D[m] is sometimes referred to as individual drive signal Vin[m]. The drive signal COM and the individual drive signal Vin are examples of a “drive signal”.

The switching circuit 31 switches, based on the print signal SI, whether to electrically couple the discharge section D[m] and the detection circuit 33. When the discharge section D[m] and the detection circuit 33 are electrically coupled, for example, a detection signal Vout[m] detected from the discharge section D[m] is supplied to the detection circuit 33 via the switching circuit 31. The detection signal Vout[m] is, for example, an analog signal indicating a change in the potential of an upper electrode Zu[m] provided in a piezoelectric element PZ[m] of the discharge section D[m]. For example, the detection signal Vout[m] is a residual vibration signal caused by vibration remaining in the discharge section D[m] after the piezoelectric element PZ[m] is driven by the individual drive signal Vin[m]. In this case, a waveform of the detection signal Vout[m] indicates, for example, a waveform of residual vibration that is vibration remaining in the discharge section D[m] after the piezoelectric element PZ[m] is driven. The residual vibration of the discharge section D[m] after the piezoelectric element PZ[m] is driven corresponds to residual vibration of a vibration plate 321 after the piezoelectric element PZ[m] is driven. The piezoelectric element PZ, the upper electrode Zu[m], and the vibration plate 321 are explained below with reference to FIG. 3.

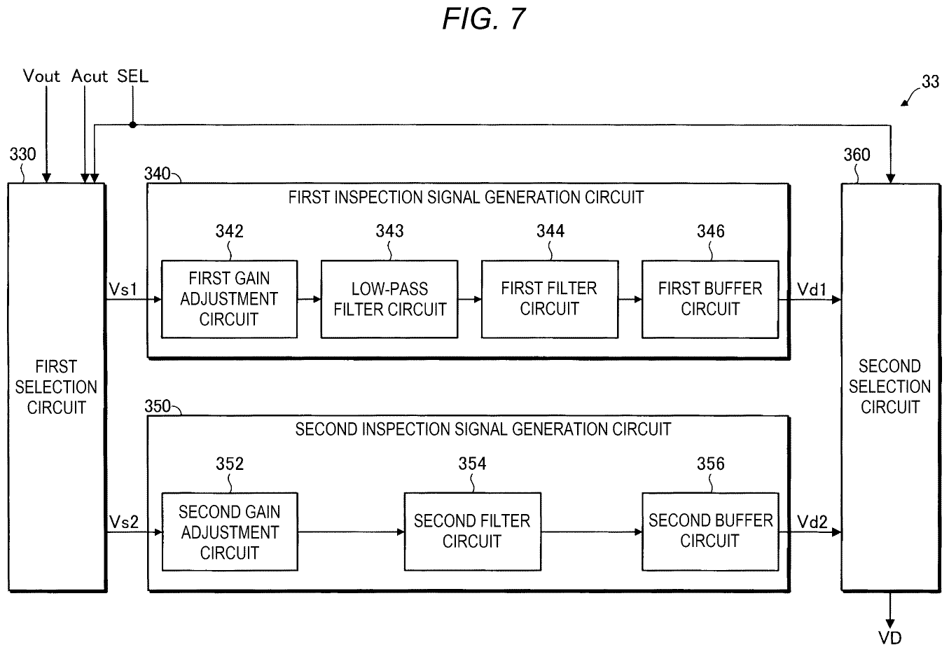

The detection circuit 33 generates an inspection signal VD[m] corresponding to the detection signal Vout[m] as a signal for determining a state of the discharge section D[m]. As explained in detail below with reference to FIG. 7 and the subsequent figures, for example, the detection circuit 33 generates the inspection signal VD[m] to imitate an attenuation wave of the detection signal Vout[m] indicating the residual vibration of the discharge section D[m]. Alternatively, the detection circuit 33 generates the inspection signal VD[m] obtained by removing frequency components other than a predetermined frequency component from the residual vibration signal. The detection circuit 33 outputs an inspection signal VD[m] corresponding to the detection signal Vout[m] to the inspection unit 6.

The inspection unit 6 determines, for example, a state of the discharge section D[m] based on the inspection signal VD[m]. For example, the inspection unit 6 determines a viscosity increased state of ink in the discharge section D[m]. In this case, it is possible to prevent the print processing from being executed in a state in which an abnormality caused by viscosity increase of the ink in the discharge section D[m] occurs. In the following explanation, processing of determining a state of the discharge section D[m] is also referred to as discharge state determination processing. In the following explanation, the discharge section D, a state of which is determined, is also referred to as determination target discharge section D.

When the discharge state determination processing is executed, the drive control section 22 generates a signal for controlling the head unit 3 such as the print signal SI. When the discharge state determination processing is executed, the drive control section 22 generates a signal for controlling the drive signal generation unit 4 such as the waveform designation signal dCOM. Accordingly, the drive control section 22 drives the discharge section D[m] as the determination target discharge section D.

When the discharge state determination processing is executed, the drive control section 22 generates the print signal SI to control the head unit 3 such that the detection signal Vout[m] corresponding to the discharge section D[m] driven as the determination target discharge section D is supplied to the detection circuit 33. Accordingly, the detection circuit 33 generates the inspection signal VD[m] corresponding to the detection signal Vout[m] detected from the discharge section D[m] driven with the determination target discharge section D. Then, based on the inspection signal VD[m] supplied from the detection circuit 33, the inspection unit 6 determines a state of the discharge section D[m] driven as the determination target discharge section D. The inspection unit 6 outputs state information Cinf including information indicating a determination result of the state of the discharge section D[m] to the control unit 2.

The inspection unit 6 may be provided in the control unit 2. For example, the control unit 2 may operate according to the control program PG stored in the storage unit 5 to function as the inspection unit 6.

As explained above, in the present embodiment, the inkjet printer 1 executes the maintenance processing. For example, the maintenance processing includes flushing processing of discharging ink from the discharge section D, wiping processing of wiping off foreign matters such as ink adhering to the vicinity of a nozzle N of the discharge section D with a wiper, and pumping processing of sucking the ink in the discharge section D with a tube pump or the like. The nozzle N is explained later with reference to FIG. 3.

For example, the ink further thickened with an increased viscosity is discharged from the discharge section D by the flushing processing. Accordingly, the viscosity of the ink in the nozzle N at a start time of the print processing can be reduced to a predetermined viscosity or less. In this case, since the ink having the increased viscosity is discharged from the discharge section D, it is possible to prevent the quality of an image printed by the print processing from being deteriorated.

The maintenance unit 8 includes a discharged ink receiving section 80 for receiving the discharged ink when the ink in the discharge section D is discharged in the flushing processing, a wiper for wiping off foreign matters such as the ink adhering to the vicinity of the nozzle N of the discharge section D, and a tube pump for sucking the ink, bubbles, and the like in the discharge section D. The discharged ink receiving section 80 is explained below with reference to FIG. 2. The wiper and the tube pump are not illustrated. Subsequently, a schematic internal structure of the inkjet printer 1 is explained with reference to FIG. 2.

FIG. 2 is a perspective view illustrating an example of the schematic internal structure of the inkjet printer 1.

As illustrated in FIG. 2, in the present embodiment, it is assumed that the inkjet printer 1 is a serial printer. Specifically, when executing the print processing, the inkjet printer 1 forms dots corresponding to the print data IMG on the recording paper P by discharging ink from the discharge sections D[m] while transporting the recording paper P in a sub scanning direction and reciprocating the head unit 3 in a main scanning direction crossing the sub scanning direction.

In the following explanation, for convenience of explanation, a three-axis orthogonal coordinate system having an X axis, a Y axis, and a Z axis orthogonal to one another is introduced as appropriate. For example, in the present embodiment, a Y1 direction along the Y axis is the sub scanning direction and an X1 direction and an X2 direction along the X axis are the main scanning direction. The X2 direction is a direction opposite to the X1 direction. In the present embodiment, as illustrated in FIG. 2, a Z1 direction along the Z axis is an ink discharge direction from the discharge section D[m]. In the following explanation, the X1 direction and the X2 direction are collectively referred to as X-axis direction, the Y1 direction and a Y2 direction opposite to the Y1 direction are collectively referred to as Y-axis direction, and the Z1 direction and a Z2 direction opposite to the Z1 direction are collectively referred to as Z-axis direction. In the present embodiment, as explained above, it is assumed that the X axis, the Y axis, and the Z axis are orthogonal to one another. However, the present disclosure is not limited to such an aspect. For example, the X axis, the Y axis, and the Z axis only have to intersect with one another.

The inkjet printer 1 according to the present embodiment includes a housing 100 and a carriage 110 capable of reciprocating in the housing 100 in the X-axis direction and mounted with four head units 3.

In the present embodiment, it is assumed that the carriage 110 houses four ink cartridges 120 corresponding inks of four colors of cyan, magenta, yellow, and black in a one-to-one relation. In the present embodiment, as explained above, it is assumed that the inkjet printer 1 includes the four head units 3 corresponding to the four ink cartridges 120 in one-to-one relation. The discharge sections D[m] receive supply of inks from the ink cartridges 120 corresponding to the head units 3 in which the discharge sections D[m] are provided. Accordingly, the discharge sections D[m] can be filled with the supplied inks and discharge the filled inks from the nozzles N. Note that the ink cartridges 120 may be provided on the outside of the carriage 110.

As explained above with reference to FIG. 1, the inkjet printer 1 according to the present embodiment includes the conveyance unit 7. The conveyance unit 7 includes a carriage conveyance mechanism 71 for reciprocating the carriage 110 in the X-axis direction and a carriage guide shaft 76 that supports the carriage 110 to be able to reciprocate in the X-axis direction. Further, the conveyance unit 7 includes a medium conveyance mechanism 73 for conveying the recording paper P and a platen 75 provided in the Z1 direction with respect to the carriage 110. For example, in the print processing, the carriage conveyance mechanism 71 reciprocates the head unit 3 in the X-axis direction along the carriage guide shaft 76 together with the carriage 110. The medium conveyance mechanism 73 conveys the recording paper P on the platen 75 in the Y1 direction. Therefore, in the print processing, the conveyance unit 7 causes the carriage conveyance mechanism 71 and the medium conveyance mechanism 73 to execute the operations explained above to thereby change the relative position of the recording paper P with respect to the head unit 3 and enable the ink to land on the entire recording paper P.

Subsequently, schematic structure of the recording head 32 is explained with reference to FIG. 3.

FIG. 3 is a cross-sectional view illustrating an example of the structure of the discharge section D. In FIG. 3, a cross section of a part of the recording head 32 when the recording head 32 is cut to include the discharge section D[m] is schematically illustrated.

The discharge section D[m] includes a cavity CV in which ink is filled, the nozzle N communicating with the cavity CV, the piezoelectric element PZ[m] that causes pressure fluctuation in the ink in the cavity CV when the individual drive signal Vin[m] is supplied, and the vibration plate 321. The discharge section D[m] discharges the ink in the cavity CV from the nozzle N when the piezoelectric element PZ[m] is driven by the individual drive signal Vin[m].

The cavity CV corresponds to a pressure chamber communicating with the nozzle N. For example, the cavity CV is a space segmented by a cavity plate 324, the a nozzle plate 323 in which the nozzle N is formed, and the vibration plate 321. The cavity CV communicates with a reservoir 325 via an ink supply port 326. The reservoir 325 communicates with the ink cartridge 120 corresponding to the discharge section D[m] via an ink intake port 327. The piezoelectric element PZ[m] includes an upper electrode Zu[m], a lower electrode Zd[m], and a piezoelectric body Zb[m] provided between the upper electrode Zu[m] and the lower electrode Zd[m]. The piezoelectric body Zb[m] is formed of, for example, a ferroelectric dielectric material.

The upper electrode Zu[m] is electrically coupled to a wire Li to which the individual drive signal Vin[m] is supplied. The lower electrode Zd[m] is electrically coupled to a wire Ld to which a base potential signal VBS is supplied. When the individual drive signal Vin[m] is supplied to the upper electrode Zu[m], a voltage is applied between the upper electrode Zu[m] and the lower electrode Zd[m]. The piezoelectric element PZ[m] is displaced in the Z1 direction or the Z2 direction according to the voltage applied between the upper electrode Zu[m] and the lower electrode Zd[m].

As explained above, the piezoelectric element PZ[m] vibrates according to the voltage applied between the upper electrode Zu[m] and the lower electrode Zd[m]. The lower electrode Zd[m] is joined to the vibration plate 321. For this reason, the piezoelectric element PZ[m] vibrates by being driven by the individual drive signal Vin[m], whereby the vibration plate 321 also vibrates. Then, the volume of the cavity CV and the pressure in the cavity CV change according to the vibration of the vibration plate 321 and the ink filled in the cavity CV is discharged from the nozzle N.

In the present embodiment, as an example, it is assumed that the piezoelectric element PZ is displaced in the Z1 direction when the potential of the individual drive signal Vin[m] supplied to the discharge section D[m] changes from low potential to high potential. That is, in the present embodiment, it is assumed that, when the potential of the individual supplied to the discharge section D[m] is high, the volume of the cavity CV provided in the discharge section D[m] is smaller compared with the volume in the case of the low potential.

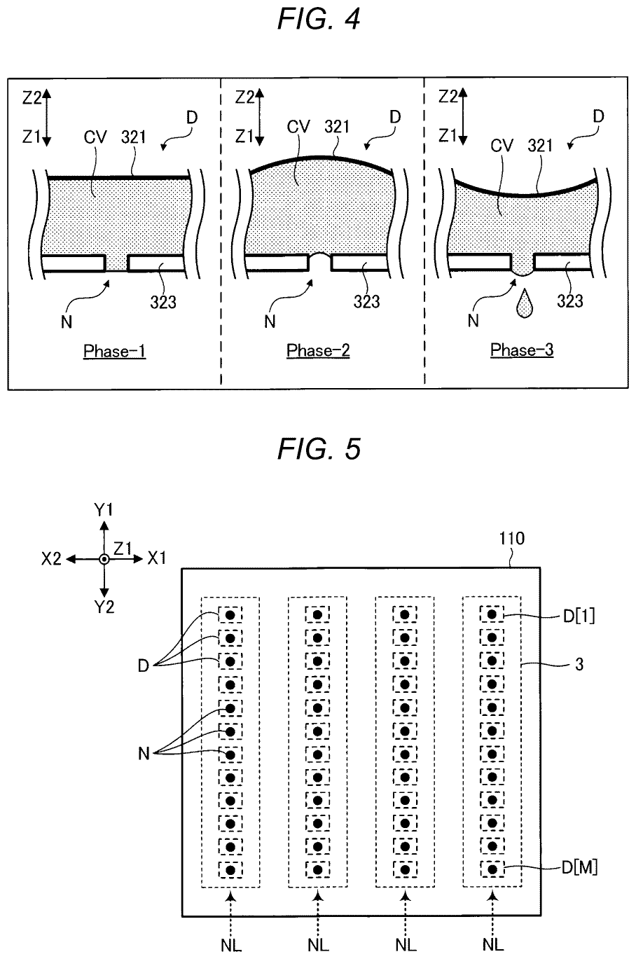

Subsequently, an ink discharge operation in the discharge section D is explained with reference to FIG. 4.

FIG. 4 is a diagram illustrating the ink discharge operation in the discharge section D.

For example, in a state of Phase-1, the drive control section 22 changes the potential of the drive signal COM supplied to the piezoelectric element PZ provided in the discharge section D to cause distortion of the piezoelectric element PZ being displaced in the Z2 direction. Accordingly, the vibration plate 321 of the discharge section D is bent in the Z2 direction. As a result, as in a state of Phase-2 illustrated in FIG. 4, the volume of the cavity CV of the discharge section D increases compared with the state of Phase-1. Subsequently, for example, in the state of Phase-2, the drive control section 22 changes the potential of the drive signal COM to cause distortion of the piezoelectric element PZ being displaced in the Z1 direction. Accordingly, the vibration plate 321 of the discharge section D is bent in the Z1 direction. As a result, as in a state of Phase-3 illustrated in FIG. 4, the volume of the cavity CV suddenly contracts and a part of the ink filling the cavity CV is discharged as ink droplets from the nozzle N communicating with the cavity CV.

As explained above, the piezoelectric element PZ and the vibration plate 321 provided in the discharge section D are displaced in the Z-axis direction when the piezoelectric element PZ provided in the discharge section D is driven by the drive signal COM. Accordingly, residual vibration occurs in the discharge section D including the vibration plate 321 after the piezoelectric element PZ is driven by the drive signal COM.

Subsequently, an example of arrangement of the nozzles N is explained with reference to FIG. 5.

FIG. 5 is a plan view illustrating an example of the arrangement of the nozzles N in the head unit 3. In FIG. 5, an example of arrangement of the four head units 3 mounted on the carriage 110 and four M nozzles N in total provided in the four head units 3 in the case in which the inkjet printer 1 is viewed from the Z1 direction is illustrated.

Nozzle rows NL are provided in the head units 3 provided in the carriage 110. Here, the nozzle row NL is a plurality of nozzles N provided to extend in a row in a predetermined direction. In the present embodiment, a case in which the nozzle rows NL include M nozzles N disposed to extend in the Y-axis direction is assumed as an example.

Subsequently, an overview of the head unit 3 is explained with reference to FIG. 6.

FIG. 6 is a block diagram illustrating an example of a configuration of the head unit 3.

As explained above with reference to FIG. 1, the head unit 3 includes the switching circuit 31, the recording head 32, and the detection circuit 33. The head unit 3 includes a wire La to which the drive signal COM is supplied from the drive signal generation unit 4, a wire Ls1 for supplying a potential signal Vzu to a high-pass filter circuit 312 explained below, and a wire Ls2 for supplying a detection signal Vout to the detection circuit 33. Further, the head unit 3 includes a wire Li[m] that supplies the individual drive signal Vin[m] to the discharge section D[m] and a wire Ld to which the base potential signal VBS is supplied.

The switching circuit 31 includes M switches SWa[1] to SWa[m] corresponding to M discharge sections D[1] to D[m] in a one-to-one relation, M switches SWs[1] to SWs[m] corresponding to the M discharge sections D[1] to D[m] in a one-to-one relation, and a connection state designation circuit 310. Further, the switching circuit 31 includes a high-pass filter circuit 312 that outputs, to the detection circuit 33, the detection signal Vout[m] obtained by removing a DC component from the potential signal Vzu[m] indicating the potential of the upper electrode Zu[m] provided in the piezoelectric element PZ[m]. The potential signal Vzu[m], from which the detection signal Vout[m] is obtained, may be grasped as a “residual vibration signal”.

The high-pass filter circuit 312 includes, for example, a capacitor C10 having one end electrically coupled to the wire Ls1 and the other end electrically coupled to the wire Ls2. The switching circuit 31 includes a resistance element R10 having one end electrically coupled to the wire La and the other end electrically coupled to the wire Ls1. The resistance element R10 functions as a bias resistor that supplies the voltage of the drive signal COM to the wire Ls1. In the following explanation, a node to which one end of the resistance element R10 is coupled is sometimes referred to as node N1 and a node to which the other end of the resistance element R10 is coupled is sometimes referred to as node N2. For example, the resistance element R10 and the capacitor C10 are coupled to the node N2. For example, the detection circuit 33 is coupled to the node N2 via the capacitor C10. In the following explanation, a node to which the capacitor C10 and the detection circuit 33 are coupled is sometimes referred to as node N3.

The connection state designation circuit 310 designates a connection state of each of the M switches SWa and the M switches SWs. For example, the connection state designation circuit 310 generates connection state designation signals Qa[m] and Qs[m] based on at least a part of the print signal SI, a latch signal LAT, and a period defining signal Tsig supplied from the drive control section 22. The connection state designation signal Qa[m] is a signal for designating on and off of the switch SWa[m]. The connection state designation signal Qs[m] is a signal for designating on and off of the switch SWs[m]. Further, the connection e designation circuit 310 generates a selection signal SEL and a detection period signal Acut based on at least a part of the print signal SI, the latch signal LAT, and the period defining signal Tsig. The selection signal SEL and the detection period signal Acut are supplied to the detection circuit 33.

In the present embodiment, it is assumed that each of the M switches SWa and the M switches SWs includes a transfer gate including a P-channel transistor and an N-channel transistor coupled in parallel. However, each of the M switches SWa and the M switches SWs may include one of a P-channel transistor and an N-channel transistor.

The switch SWa[m] switches, based on the connection state designation signal Qa[m], conduction and non-conduction between the wire La and the upper electrode Zu[m] of the piezoelectric element PZ[m] provided in the discharge section D[m]. That is, the switch SWa[m] switches, based on the connection state designation signal Qa[m], conduction and non-conduction between the wire La and the wire Li[m] coupled to the upper electrode Zu[m]. In the present embodiment, the switch SWa[m] is turned on when the connection state designation signal Qa[m] is at a high level and is turned off when the connection state designation signal Qa[m] is at a low level. When the switch SWa[m] is turned on, the drive signal COM supplied to the wire La is supplied to the upper electrode Zu[m] of the discharge section D[m] via the wire Li[m] as the individual drive signal Vin[m]. That is, the individual drive signal Vin[m] is the drive signal COM supplied to, via the switch SWa[m], the piezoelectric element PZ[m] provided in the discharge section D[m].

The switch SWs[m] switches, based on the connection state designation signal Qs[m], conduction and non-conduction between the wire Ls1 and the upper electrode Zu[m] of the piezoelectric element PZ[m] provided in the discharge section D[m]. That is, the switch SWs[m] switches, based on the connection state designation signal Qs[m], conduction and non-conduction between the wire Ls1 and the wire Li[m] coupled to the upper electrode Zu[m]. In the present embodiment, the switch SWs[m] is turned on when the connection state designation signal Qs[m] is at the high level and is turned off when the connection state designation signal Qs[m] is at the low level.

For example, the connection state designation signal Qs[m] changes to the high level when residual vibration of the discharge section D[m] is detected. Accordingly, residual vibration of the determination target discharge section D is detected. When the switch SWs[m] is turned on, the potential signal Vzu[m] indicating the potential of the upper electrode Zu[m] of the piezoelectric element PZ[m] provided in the determination target discharge section D[m] is supplied to the high-pass filter circuit 312 via the wire Li[m] and the wire Ls1. Then, the high-pass filter circuit 312 supplies the detection signal Vout[m] obtained by removing a DC component of the potential signal Vzu[m] to the detection circuit 33 via the wire Ls2. The detection circuit 33 generates the inspection signal VD[m] corresponding to the detection signal Vout[m].

Incidentally, in order to drive the piezoelectric element PZ, the drive signal COM having large amplitude is necessary. However, since the detection circuit 33 is an analog signal processing circuit, a large dynamic range is unnecessary. For this reason, in the present embodiment, high power supply potential of the detection circuit 33 is smaller compared with maximum potential of the drive signal COM. For example, the maximum potential of the drive signal COM is approximately 42 V, the high power supply potential of the detection circuit 33 is approximately 3.3 V, and low power supply potential of the detection circuit 33 is approximately 0 V. As explained above, the high power supply potential of the detection circuit 33 is lower compared with the maximum potential of the drive signal COM. Therefore, the coupling of the piezoelectric element PZ and the detection circuit 33 is not suitable for DC coupling. In the present embodiment, by removing the DC component of the potential signal Vzu with the high-pass filter circuit 312, it is possible to cause the detection circuit 33 to normally operate.

Subsequently, an overview of the detection circuit 33 is explained with reference to FIG. 7.

FIG. 7 is a block diagram illustrating an example of a configuration of the detection circuit 33.

The detection circuit 33 includes a first selection circuit 330, a first inspection signal generation circuit 340, a second inspection signal generation circuit 350, and a second selection circuit 360.

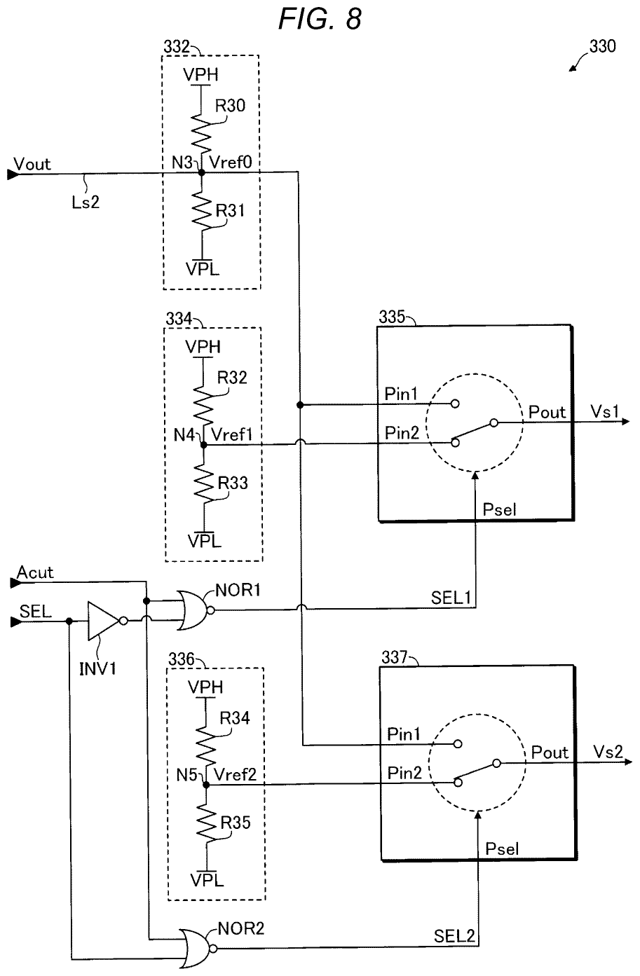

The first selection circuit 330 selects, based on the selection signal SEL and the detection period signal Acut, as a first input signal Vs1, one of the detection signal Vout and first reference potential Vref1 illustrated in FIG. 8. That is, the first selection circuit 330 supplies, based on the selection signal SEL and the detection period signal Acut, one of the detection signal Vout and the first reference potential Vref1 to the first inspection signal generation circuit 340 as the first input signal Vs1.

The first selection circuit 330 selects, based on the selection signal SEL and the detection period signal Acut, as a second input signal Vs2, one of the detection signal Vout and second reference potential Vref2 illustrated in FIG. 8. That is, the first selection circuit 330 supplies, based on the selection signal SEL and the detection period signal Acut, one of the detection signal Vout and the second reference potential Vref2 to the second inspection signal generation circuit 350 as the second input signal Vs2.

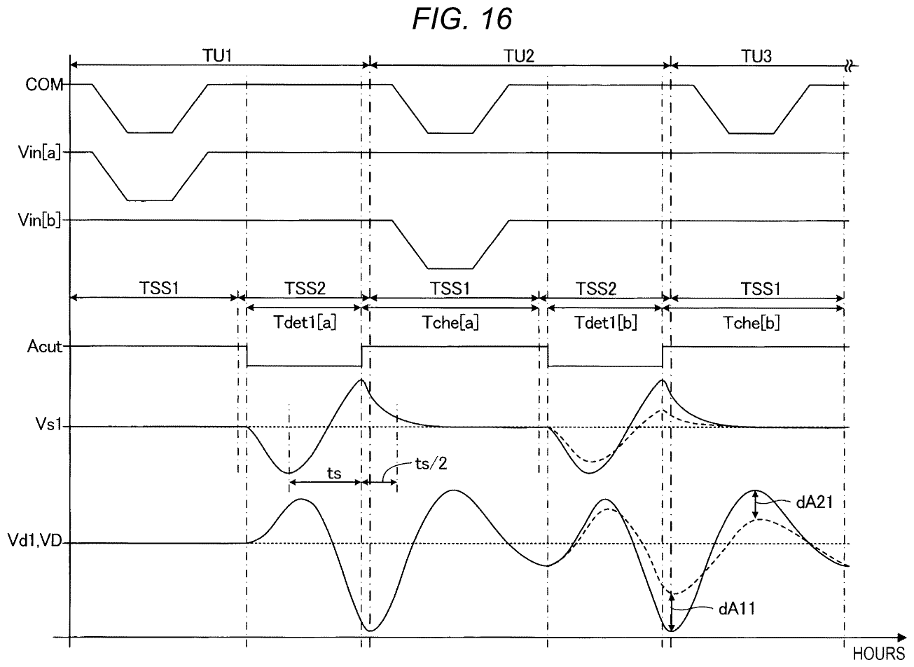

The first inspection signal generation circuit 340 generates, for example, a first inspection signal Vd1 simulating an attenuation wave of the detection signal Vout. Accordingly, the first inspection signal Vd1 is generated as a pseudo residual vibration signal simulating the residual vibration of the discharge section D. In the present embodiment, it is assumed that the first inspection signal Vd1 is generated based on residual vibration equal to or larger than one quarter cycle and smaller than one cycle of the discharge section D. For example, the first inspection signal generation circuit 340 generates a pseudo residual vibration signal based on the detection signal Vout equal to or larger than one quarter cycle and smaller than one cycle and outputs the generated pseudo residual vibration signal as the first inspection signal Vd1. A cycle of the first inspection signal Vd1 output from the first inspection signal generation circuit 340 is equal to or larger than one cycle as illustrated in FIG. 16 referred to below.

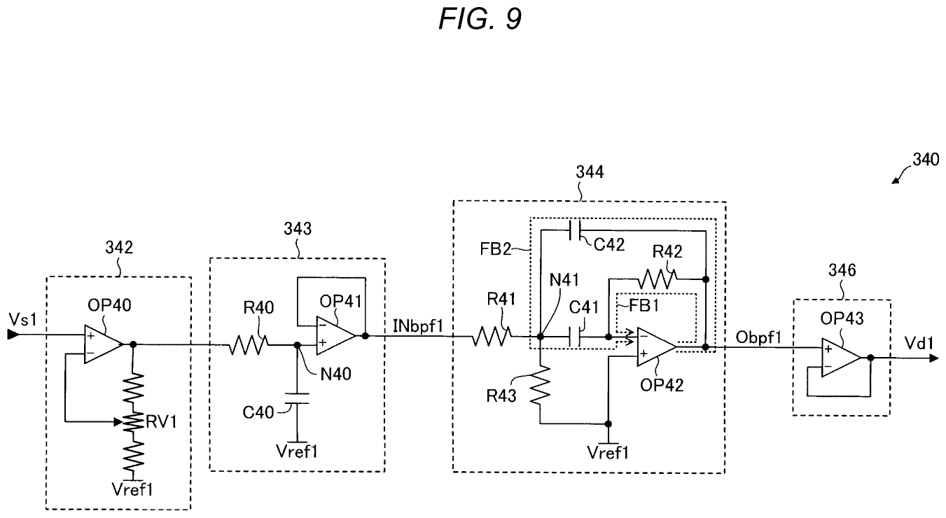

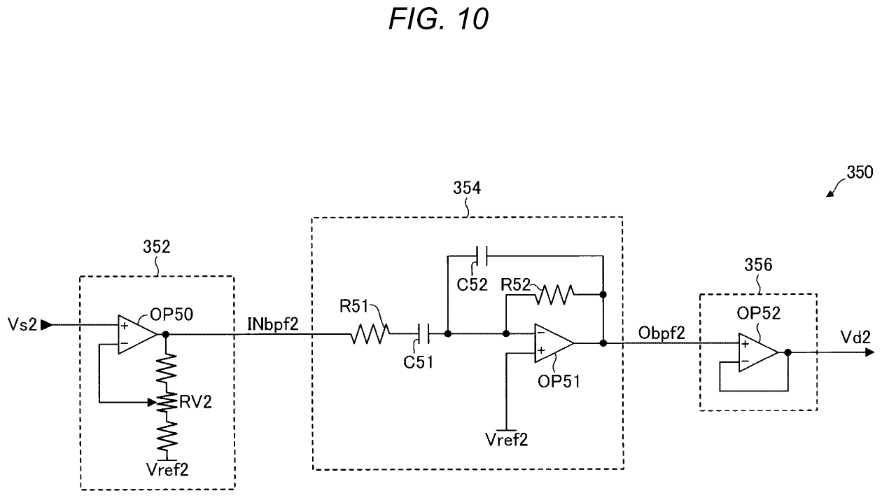

The first inspection signal generation circuit 340 includes, for example, a first gain adjustment circuit 342, a low-pass filter circuit 343, a first filter circuit 344, and a first buffer circuit 346. The first gain adjustment circuit 342 adjusts the amplitude of the first input signal Vs1. The low-pass filter circuit 343 attenuates a high-frequency component of the first input signal Vs1. The high frequency component is, for example, a frequency component higher than a frequency band of residual vibration. The first filter circuit 344 is a multiple feedback type bandpass filter. The first buffer circuit 346 converts impedance and outputs the first inspection signal Vd1 having low impedance. The first inspection signal generation circuit 340 is an example of a “signal generation section”, the first filter circuit 344 is an example of a “filter circuit”, and the low-pass filter circuit 343 is an example of a “low-pass filter”. Details of the first inspection signal generation circuit 340 are explained below with reference to FIG. 9.

The second inspection signal generation circuit 350 generates, for example, a second inspection signal Vd2 obtained by removing a frequency component other than a predetermined frequency component from the detection signal Vout. Thus, the second inspection signal Vd2 is generated as a detection residual vibration signal corresponding to a signal having the predetermined frequency component in the detection signal Vout indicating the residual vibration of the discharge section D. The predetermined frequency component is, for example, a frequency component corresponding to a frequency band of the residual vibration. In the present embodiment, it is assumed that the second inspection signal Vd2 is generated based on residual vibration equal to or larger than one cycle of the discharge section D. For example, the second inspection signal generation circuit 350 generates the detection residual vibration signal based on the detection signal Vout equal to or larger than one cycle and outputs the generated detection residual vibration signal as the second inspection signal Vd2.

The second inspection signal generation circuit 350 includes, for example, a second gain adjustment circuit 352 configured the same as the first gain adjustment circuit 342, a second filter circuit 354, and a second buffer circuit 356 configured the same as the first buffer circuit 346. The second filter circuit 354 is a bandpass filter that allows a signal having the predetermined frequency component to pass therethrough. The details of the second inspection signal generation circuit 350 are explained below with reference to FIG. 10.

The second selection circuit 360 selects, based on the selection signal SEL, one of the first inspection signal Vd1 and the second inspection signal Vd2 as the inspection signal VD. That is, the second selection circuit 360 supplies, based on the selection signal SEL, one of the first inspection signal Vd1 and the second inspection signal Vd2 as the inspection signal VD to the inspection unit 6. For example, the second selection circuit 360 may exclusively switch, based on the selection signal SEL, whether to supply the first inspection signal Vd1 to the inspection unit 6 or to supply the second inspection signal Vd2 to the inspection unit 6. In the present embodiment, when the selection signal SEL is at the high level, the second selection circuit 360 supplies the first inspection signal Vd1 to the inspection unit 6 as the inspection signal VD and, when the selection signal SEL is at the low level, the second selection circuit 360 supplies the second inspection signal Vd2 to the inspection unit 6 as the inspection signal VD.

As explained above, in the present embodiment, it is possible to switch, based on the selection signal SEL, whether the inspection unit 6 determines the state of the discharge section D based on the first inspection signal Vd1 or the inspection unit 6 determines the state of the discharge section D based on the second inspection signal Vd2. Note that each of a case in which the inspection unit 6 determines the state of the discharge section D based on the first inspection signal Vd1 and a case in which the inspection unit 6 determines the state of the discharge section D based on the second inspection signal Vd2 may be grasped as a mode in determining the state of the discharge section D. In the following explanation, the case in which the inspection unit 6 determines the state of the discharge section D based on the first inspection signal Vd1 is referred to as a first mode and a case in which the inspection unit 6 determines the state of the discharge section D based on the second inspection signal Vd2 is referred to as a second mode. In this case, the operation of the inspection unit 6 is also explained as follows. For example, the inspection unit 6 determines the state of the discharge section D in a mode selected based on the selection signal SEL out of a plurality of modes including the first mode and the second mode.

In the present embodiment, as explained above, the first inspection signal Vd1 is generated based on the residual vibration smaller than one cycle of the discharge section D and the second inspection signal Vd2 is generated based on the residual vibration equal to or larger than one cycle of the discharge section D. For this reason, when the state of the discharge section D is determined based on the first inspection signal Vd1, a time allocated to the detection of the residual vibration of the discharge section D can be reduced compared with the case in which the state of the discharge section D is determined based on the second inspection signal Vd2. Accordingly, in the present embodiment, it is possible to prevent the time required to determine the states of the plurality of discharge sections D from increasing.

Subsequently, an overview of the first selection circuit 330 is explained with reference to FIG. 8.

FIG. 8 is a circuit diagram illustrating an example of a configuration of the first selection circuit 330.

The first selection circuit 330 includes a reference potential generation circuit 332, a first reference potential generation circuit 334, a second reference potential generation circuit a first 336, switching circuit 335, a second switching circuit 337, an inverter INV1, and NOR circuits NOR1 and NOR2. The first switching circuit 335 is an example of a “switching section”.

The reference potential generation circuit 332 includes resistance elements R30 and R31 coupled in series between a wire to which potential VPH is supplied and a wire to which potential VPL is supplied. The potential VPH is high power supply potential of the detection circuit 33 and the potential VPL is low power supply potential of the detection circuit 33. One end of the resistance element R30 is coupled to the wire to which the potential VPH is supplied and the other end of the resistance element R30 is coupled to the wire Ls2 to which the detection signal Vout is supplied. One end of the resistance element R31 is coupled to the wire Ls2 and the other end of the resistance element R31 is coupled to the wire to which the potential VPL is supplied. That is, the detection signal Vout is supplied to the node N3 to which the resistance element R30 and the resistance element R31 are electrically coupled. Resistance values of the resistance elements R30 and R31 are set such that a reference potential Vref, which is the potential of the node N3 in the case in which the potential of the node N2 illustrated in FIG. 6 is maintained at constant potential, is the center potential of the potential VPH and the potential VPL. For example, by setting the resistance value of each of the resistance elements R30 and R31 to 150 kΩ, the reference potential Vref0 is set to the center potential of the potential VPH and the potential VPL. The node N3 is also a node to which the capacitor C10 is coupled as explained with reference to FIG. 6.

The first reference potential generation circuit 334 includes resistance elements R32 and R33 coupled in series between the wire to which the potential VPH is supplied and the wire to which the potential VPL is supplied. One end of the resistance element R32 is coupled to the wire to which the potential VPH is supplied, the other end of the resistance element R33 is coupled to one end of the resistance element R33, and the other end of the resistance element R33 is coupled to the wire to which the potential VPL is supplied. In the following explanation, a node to which the resistance element R32 and the resistance element R33 are coupled is sometimes referred to as node N4. Resistance values of the resistance elements R32 and R33 are set, for example, such that the first reference potential Vref1, which is the potential of the node N4, is the center potential of the potential VPH and the potential VPL. An output impedance of the first reference potential generation circuit 334 is preferably smaller than the output impedance of the reference potential generation circuit 332 in order to, when noise occurs in the node N4, reduce the influence of the noise on the first inspection signal generation circuit 340. For example, by setting the resistance value of each of the resistance elements R32 and R33 to 1.5 kΩ, the first reference potential Vref1 is set to the center potential of the potential VPH and the potential VPL. The first reference potential Vref1 is an example of a “constant potential”.

The second reference potential generation circuit 336 includes resistance elements R34 and R35 coupled in series between the wire to which the potential VPH is supplied and the wire to which the potential VPL is supplied. One end of the resistance element R34 is coupled to the wire to which the potential VPH is supplied, the other end of the resistance element R34 is coupled to one end of the resistance element R35, and the other end of the resistance element R35 is coupled to the wire to which the potential VPL is supplied. In the following explanation, a node to which the resistance element R34 and the resistance element R35 are coupled is sometimes s referred to as node N5. Resistance values of the resistance elements R34 and R35 are set, for example, such that the second reference potential Vref2, which is the potential of the node N5, is the center potential of the potential VPH and the potential VPL. The output impedance of the second reference potential generation circuit 336 is preferably smaller than the output impedance of the reference potential generation circuit 332 in order to, when noise occurs in the node N5, reduce the influence of the noise on the second inspection signal generation circuit 350. For example, by setting the resistance value of each of the resistance elements R34 and R35 to 1.5 kΩ, the second reference potential Vref2 is set to the center potential of the potential VPH and the potential VPL.

Each of the first switching circuit 335 and the second switching circuit 337 includes, for example, a first input terminal Pin1, a second input terminal Pin2, an output terminal Pout, and a control terminal Psel. Each of the first switching circuit 335 and the second switching circuit 337 switches, according to a signal supplied to the control terminal Psel, whether to make the first input terminal Pin1 and the output terminal Pout conductive or make the second input terminal Pin2 and the output terminal Pout conductive. For example, when a level of the control terminal Psel is the high level, each of the first switching circuit 335 and the second switching circuit 337 makes the first input terminal Pin1 and the output terminal Pout conductive and makes the second input terminal Pin2 and the output terminal Pout non-conductive. When the level of the control terminal Psel is the low level, each of the first switching circuit 335 and the second switching circuit 337 makes the second input terminal Pin2 and the output terminal Pout conductive and makes the first input terminal Pin1 and the output terminal Pout non-conductive.

For example, the first input terminal Pin1 of the first switching circuit 335 is coupled to the node N3, the second input terminal Pin2 of the first switching circuit 335 is coupled to the node N4, and the output terminal Pout of the first switching circuit 335 is coupled to the first inspection signal generation circuit 340. That is, the detection signal Vout is input to the first input terminal Pin1 of the first switching circuit 335 and the first reference potential Vref1 is supplied to the second input terminal Pin2 of the first switching circuit 335. An input selection signal SEL1 is supplied to the control terminal Psel of the first switching circuit 335. For example, the first inspection signal generation circuit 340 starts outputting the first inspection signal Vd1 indicating the pseudo residual vibration signal after switching from a state of being coupled to the second input terminal Pin2 via the output terminal Pout to a state of being coupled to the first input terminal Pin1 via the output terminal Pout. The input selection signal SEL1 is an example of a “switching signal”.

For example, the first input terminal Pin1 of the second switching circuit 337 is coupled to the node N3, the second input terminal Pin2 of the second switching circuit 337 is coupled to the node N5, and the output terminal Pout of the second switching circuit 337 is coupled to the second inspection signal generation circuit 350. That is, the detection signal Vout is input to the first input terminal Pin1 of the second switching circuit 337 and the second reference potential Vref2 is supplied to the second input terminal Pin2 of the second switching circuit 337. An input selection signal SEL2 is supplied to the control terminal Psel of the second switching circuit 337.

The inverter INV1 outputs an inverted signal of the selection signal SEL supplied from the connection state designation circuit 310 to the NOR circuit NOR1. The inverted signal of the selection signal SEL is a signal obtained by inverting a level of the selection signal SEL. Specifically, the inverted signal of the selection signal SEL is a low level signal when the selection signal SEL is at the high level and is a high level signal when the selection signal SEL is at the low level.

The NOR circuit NOR1 outputs an operation result of a NOR of the detection period signal Acut supplied from the connection state designation circuit 310 and the inverted signal of the selection signal SEL to the control terminal Psel of the first switching circuit 335 as the input selection signal SEL1.

The NOR circuit NOR2 outputs an operation result of a NOR of the selection signal SEL and the detection period signal Acut supplied from the connection state designation circuit 310 to the control terminal Psel of the second switching circuit 337 as the input selection signal SEL2.

When the selection signal SEL is at the high level and the detection period signal Acut is at the low level, the first selection circuit 330 illustrated in FIG. 8 supplies the detection signal Vout to the first inspection signal generation circuit 340 as the first input signal Vs1. When the selection signal SEL is at the high level and the detection period signal Acut is at the high level, the first selection circuit 330 supplies the first reference potential Vref1 to the first inspection signal generation circuit 340 as the first input signal Vs1. When the selection signal SEL is at the low level, the first selection circuit 330 supplies the first reference potential Vref1 to the first inspection signal generation circuit 340 as the first input signal Vs1 regardless of the level of the detection period signal Acut.

When the selection signal SEL is at the low level and the detection period signal Acut is at the low level, the first selection circuit 330 supplies the detection signal Vout to the second inspection signal generation circuit 350 as the second input signal Vs2. When the selection signal SEL is at the low level and the detection period signal Acut is at the high level, the first selection circuit 330 supplies the second reference potential Vref2 to the second inspection signal generation circuit 350 as the second input signal Vs2. When the selection signal SEL is at the high level, the first selection circuit 330 supplies the second reference potential Vref2 to the second inspection signal generation circuit 350 as the second input signal Vs2 regardless of the level of the detection period signal Acut.

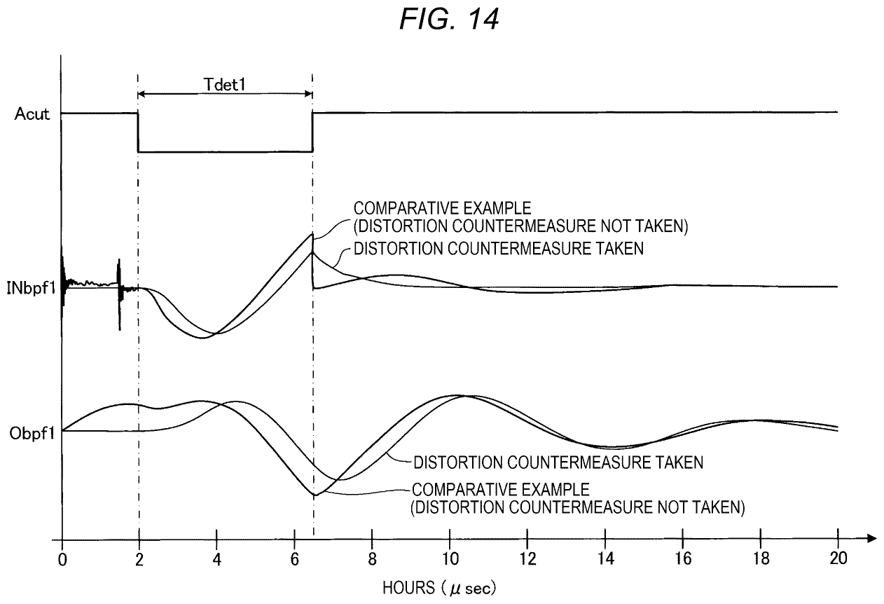

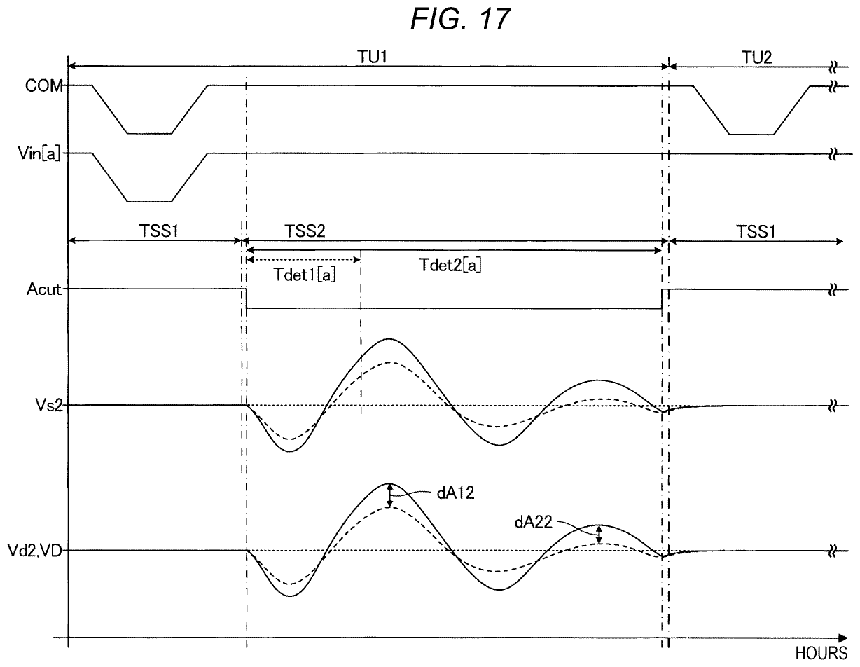

As explained above, in the present embodiment, when the selection signal SEL is at the high level, the first inspection signal generation circuit 340 is selected as a circuit that generates the inspection signal VD and, when the selection signal SEL is at the low level, the second inspection signal generation circuit 350 is selected as a circuit that generates the inspection signal VD. In a period in which the detection period signal Acut is at the low level, the detection signal Vout is input to the first inspection signal generation circuit 340 or the second inspection signal generation circuit 350. In the following explanation, the period in which the detection period signal Acut is at the low level is also referred to as detection period Tdet1 or Tdet2 as illustrated in FIGS. 14 and 17 and the like.

A configuration of the first selection circuit 330 is not limited to the example illustrated in FIG. 8. For example, the second reference potential generation circuit 336 may be omitted. In this case, the second input terminal Pin2 of the second switching circuit 337 is coupled to, for example, the node N4.

Subsequently, an overview of the first inspection signal generation circuit 340 is explained with reference to FIG. 9.

FIG. 9 is a circuit diagram illustrating an example of a configuration of the first inspection signal generation circuit 340.

As explained above with reference to FIG. 7, the first inspection signal generation circuit 340 includes the first gain adjustment circuit 342, the low-pass filter circuit 343, the first filter circuit 344, and the first buffer circuit 346.

The first gain adjustment circuit 342 is, for example, a negative feedback type amplifier including an operational amplifier OP40 and a variable resistor RV1. For example, the first input signal Vs1 is supplied to a non-inverting input terminal of the operational amplifier OP40 from the first switching circuit 335 and a signal obtained by dividing an output signal of the operational amplifier OP40 with the variable resistor RV1 is fed back to an inverting input terminal of the operational amplifier OP40. For example, one end of the variable resistor RV1 is coupled to an output terminal of the operational amplifier OP40, the other end of the variable resistor RV1 is coupled to a wire to which the first reference potential Vref1 is supplied, and a moving contact of the variable resistor RV1 is coupled to the inverting input terminal of the operational amplifier OP40. For example, the first gain adjustment circuit 342 can output a signal obtained by adjusting the amplitude of the first input signal Vs1 to the low-pass filter circuit 343 by adjusting the position of the moving contact of the variable resistor RV1.

The low-pass filter circuit 343 includes, for example, a resistance element R40, a capacitor C40, and an operational amplifier OP41. One end of the resistance element R40 is coupled to an output terminal of the operational amplifier OP40 of the first gain adjustment circuit 342 and the other end of the resistance element R40 is coupled to the node N40. One end of the capacitor C40 is coupled to the node N40 and the other end of the capacitor C40 is coupled to the wire to which the first reference potential Vref1 is supplied. A non-inverting input terminal of an operational amplifier OP42 is coupled to the node N40 and an inverting input terminal of the operational amplifier OP42 is coupled to an output terminal of the operational amplifier OP42. A first filter input signal INbpf1, which is a signal of the output terminal of the operational amplifier OP42, is input to the first filter circuit 344. That is, the first filter input signal INbpf1 obtained by attenuating a high frequency component from a signal in which the amplitude of the first input signal Vs1 is adjusted is input to the first filter circuit 344.

The first filter circuit 344 is, for example, a multiple feedback type bandpass filter including resistance elements R41, R42, and R43, capacitors C41 and C42, and the operational amplifier OP42.

One end of the resistance element R41 is coupled to the output terminal of the operational amplifier OP41 of the low-pass filter circuit 343 and the other end of the resistance element R41 is coupled to the node N41. One end of the capacitor C41 is coupled to the node N41 and the other end of the capacitor C41 is coupled to the inverting input terminal of the operational amplifier OP42. One end of the resistance element R42 is coupled to the inverting input terminal of the operational amplifier OP42 and the other end of the resistance element R42 is coupled to the output terminal of the operational amplifier OP42. A non-inverting input terminal of the operational amplifier OP42 is coupled to the wire to which the first reference potential Vref1 is supplied. One end of the resistance element R43 is coupled to the node N41 and the other end of the resistance element R43 is coupled to the wire to which the first reference potential Vref1 is supplied. One end of the capacitor C42 is coupled to the node N41 and the other end of the capacitor C42 is coupled to the output terminal of the operational amplifier OP42.

For example, the first filter input signal INbpf1 is input to the inverting input terminal of the operational amplifier OP42 via the resistance element R41 and the capacitor C41. That is, the first input signal Vs1 is input to the inverting input terminal of the operational amplifier OP42 via the first gain adjustment circuit 342, the low-pass filter circuit 343, the resistance element R41, and the capacitor C41. Then, an output signal of the operational amplifier OP42 is fed back to the inverting input terminal of the operational amplifier OP42 by a first feedback path FB1. The output signal of the operational amplifier OP42 is fed back to the inverting input terminal of the operational amplifier OP42 by a second feedback path FB2 different from the first feedback path FB1. Note that the first feedback path FB1 is, for example, a feedback path that feeds back the output signal of the operational amplifier OP42 to the inverting input terminal of the operational amplifier OP42 via the resistance element R42. The second feedback path FB2 is, for example, a feedback path that feeds back the output signal of the operational amplifier OP42 to the inverting input terminal of the operational amplifier OP42 via the capacitor C42 and the capacitor C41. As explained above, the first filter circuit 344 includes the first feedback path FB1 and the second feedback path FB2 as a feedback path that feeds back the output signal of the operational amplifier OP42 to the inverting input terminal of the operational amplifier OP42.

The output signal of the operational amplifier OP42 is supplied to the first buffer circuit 346 as a first filter output signal Obpf1.

The first buffer circuit 346 is a buffer that converts impedance and outputs the first inspection signal Vd1 having low impedance. For example, the first buffer circuit 346 includes a voltage follower using an operational amplifier OP43. Accordingly, the first filter output signal Obpf1 supplied to the first buffer circuit 346 is output from the first buffer circuit 346 as the first inspection signal Vd1 having low impedance.

Subsequently, a calculation formula for an amplification ratio, a center frequency, and a Q value of the first filter circuit 344 is explained with the amplification ratio represented as H and the center frequency represented as f₀. The Q value is a parameter obtained by dividing the center frequency f₀ by a passband width. The passband width is, for example, a bandwidth specified by a frequency at which the amplification ratio H is −3 dB.

A general transfer function of a bandpass filter is represented by Expression (1) when the potential of an input signal is represented as Vi, the potential of an output signal is represented as Vo, and “2πf₀” is “ω₀”. In the following expression, “.” indicating multiplication is used as appropriate.

$$\frac{V o}{V i} = \frac{H \cdot \frac{{ω}_{0}}{Q}}{{S}^{2} + S \cdot \frac{{ω}_{0}}{Q} + {ω}_{0}^{2}} \qquad ( 1 )$$

The transfer function of the first buffer circuit 346 is represented by Expression (2) when the potential of the first filter input signal INbpf1 is represented as Vi and the potential of the first filter output signal Obpf1 is represented as Vo. In the following expression, a resistance value of a resistance element and a capacitance value of a capacitor are indicated by using a sign obtained by changing a numeral at the end of a sign of the element to a subscript. For example, “R₄₁”, “R₄₂”, and “R₄₃” in Expression (2) respectively indicate resistance values of the resistance elements R41, R42, and R43 and “C₄₁” and “C₄₂” in Expression (2) respectively indicate capacitance values of the capacitors C41 and C42.

$$\frac{V o}{V i} = \frac{\frac{- 1}{{C}_{42} \cdot {R}_{41}} \cdot S}{{S}^{2} + S \cdot \frac{1}{{R}_{43}} \cdot ( \frac{1}{{C}_{41}} + \frac{1}{{C}_{42}} ) + \frac{1}{{C}_{41} \cdot {C}_{42} \cdot {R}_{43}} \cdot ( \frac{1}{{R}_{41}} + \frac{1}{{R}_{42}} )} \qquad ( 2 )$$

From Expressions (1) and (2), the amplification ratio H, the center frequency f₀, and the Q value of the first filter circuit 344 are respectively represented by Expressions (3), (4), and (5).

$$H = \frac{- 1}{\frac{{R}_{41}}{{R}_{43}} \cdot ( 1 + \frac{{C}_{42}}{{C}_{41}} )} \qquad ( 3 )$$

$$Q = \frac{1}{( \sqrt{( \frac{{R}_{41} \cdot {R}_{42}}{{R}_{41} + {R}_{42}} ) \cdot \frac{1}{{R}_{43}}} ) \cdot ( \sqrt{\frac{{C}_{41}}{{C}_{42}}} + \sqrt{\frac{{C}_{42}}{{C}_{41}}} )} \qquad ( 4 )$$

$${f}_{0} = \frac{1}{2 π \sqrt{{C}_{41} \cdot {C}_{42} \cdot ( \frac{{R}_{41} \cdot {R}_{42}}{{R}_{41} + {R}_{42}} ) \cdot {R}_{43}}} \qquad ( 5 )$$

Here, when the first buffer circuit 346 is designed under conditions of “C=C₄₁=C₄₂” and “R=R₄₁=R₄₂”, the amplification ratio H, the center frequency f₀, and the Q value are respectively represented by Expressions (6), (7), and (8) from Expressions (3), (4), and (5).

$$H = \frac{- {R}_{43}}{2 R} \qquad ( 6 )$$

$$Q = \sqrt{\frac{{R}_{43}}{2 R}} \qquad ( 7 )$$

$${f}_{0} = \frac{1}{2 π \cdot C \sqrt{\frac{R \cdot {R}_{43}}{2}}} \qquad ( 8 )$$

From Expressions (6) and (7), it is seen that the amplification ratio H is determined by resistance values of the resistance elements R41 and R42 and a resistance value of the resistance element R43 and the Q value is proportional to a positive square root of the absolute value of the amplification ratio.

A configuration of the first inspection signal generation circuit 340 is not limited to the example illustrated in FIGS. 7 and 9. For example, the first gain adjustment circuit 342 may be provided between the first filter circuit 344 and the first buffer circuit 346. Alternatively, a part or all of the first gain adjustment circuit 342, the low-pass filter circuit 343, and the first buffer circuit 346 may be omitted from the first inspection signal generation circuit 340 illustrated in FIG. 9.

Subsequently, an overview of the second inspection signal generation circuit 350 is explained with reference to FIG. 10.

FIG. 10 is a circuit diagram illustrating an example of a configuration of the second inspection signal generation circuit 350.

As explained with reference to FIG. 7, the second inspection signal generation circuit 350 includes the second gain adjustment circuit 352, the second filter circuit 354, and the second buffer circuit 356.

The second gain adjustment circuit 352 is a negative feedback type amplifier configured the same as the first gain adjustment circuit 342 illustrated in FIG. 9. For example, the second gain adjustment circuit 352 includes an operational amplifier OP50 that receives, at the non-inverting input terminal, the second input signal Vs2 supplied from the second switching circuit 337 and a variable resistor RV2 that divides the voltage of an output signal of the operational amplifier OP50 and feeds back the signal, the voltage of which is divided, to an inverting input terminal of the operational amplifier OP50. One end of the variable resistor RV2 is coupled to an output terminal of the operational amplifier OP50, the other end of the variable resistor RV2 is coupled to a wire to which the second reference potential Vref2 is supplied, and a moving contact of the variable resistor RV2 is coupled to the inverting input terminal of the operational amplifier OP50. For example, the second gain adjustment circuit 352 can output, to the second filter circuit 354, a second filter input signal INbpf2 obtained by adjusting the amplitude of the second input signal Vs2 by adjusting the position of the moving contact of the variable resistor RV2.

The second filter circuit 354 is, for example, a bandpass filter including resistance elements R51 and R52, capacitors C51 and C52, and an operational amplifier OP51 and allows a signal of a predetermined frequency component to pass therethrough.

One end of the resistance element R51 is coupled to the output terminal of the operational amplifier OP50 of the second gain adjustment circuit 352, the other end of the resistance element R51 is coupled to one end of the capacitor C51, and the other end of the capacitor C51 is coupled to the inverting input terminal of the operational amplifier OP51. One end of the capacitor C52 is coupled to the inverting input terminal of the operational amplifier OP51 and the other end of the capacitor C52 is coupled to the output terminal of the operational amplifier OP51. One end of the resistance element R52 is coupled to the inverting input terminal of the operational amplifier OP51 and the other end of the resistance element R52 is coupled to the output terminal of the operational amplifier OP51. The non-inverting input terminal of the operational amplifier OP51 is coupled to the wire to which the second reference potential Vref2 is supplied.

For example, the second filter input signal INbpf2 is input to the inverting input terminal of the operational amplifier OP51 via the resistance element R51 and the capacitor C51. That is, the second input signal Vs2 is input to the inverting input terminal of the operational amplifier OP51 via the second gain adjustment circuit 352, the resistance element R51, and the capacitor C51. Then, an output signal of the operational amplifier OP41 is fed back to the inverting input terminal of the operational amplifier OP41 by a feedback path in which the resistance element R52 and the capacitor C52 are coupled in parallel.

An output signal of the operational amplifier OP51 is supplied to the second buffer circuit 356 as a second filter output signal Obpf2.

The second buffer circuit 356 is a buffer that converts impedance and outputs the second inspection signal Vd2 having low impedance. For example, like the first buffer circuit 346 illustrated in FIG. 9, the second buffer circuit 356 includes a voltage follower using the operational amplifier OP52. Accordingly, the second filter output signal OBpf2 supplied to the second buffer circuit 356 is output from the second buffer circuit 356 as the second inspection signal Vd2 having low impedance.

Subsequently, a calculation formula for a cutoff frequency of a low frequency band, a cutoff frequency of a high frequency band, and an amplification ratio of the second filter circuit 354 is explained with the cutoff frequency of the low frequency band represented as f_{LPF}, the cutoff frequency of the high frequency band represented as f_{HPF}, and the amplification ratio represented as G.

The cutoff frequency f_{LPF} of the second filter circuit 354 is a cutoff frequency of a low-pass filter including the capacitor C52 and the resistance element R52 and is represented by Expression (9). The cutoff frequency f_{HPF} of the second filter circuit 354 is a cutoff frequency of a high-pass filter including the capacitor C51 and the resistance element R51 and is represented by Expression (10).

$${f}_{LPF} = \frac{1}{2 π \cdot {C}_{52} \cdot {R}_{52}} \qquad ( 9 )$$

$${f}_{HPF} = \frac{1}{2 π \cdot {C}_{51} \cdot {R}_{51}} \qquad ( 10 )$$

The amplification ratio G of the second filter circuit 354 is represented by Expression (11), Expression (12), and Expression (13). An angular frequency ω[rad] in Expressions (12) and (13) indicates an angular frequency corresponding to a center frequency of the second filter circuit 354 functioning as a bandpass filter.

$$G = \frac{{Z}_{2}}{{Z}_{1}} \qquad ( 11 )$$

$${Z}_{1} = \sqrt{{( {R}_{51} )}^{2} + {( \frac{1}{ω \cdot {C}_{51}} )}^{2}} \qquad ( 12 )$$

$${Z}_{2} = \frac{{R}_{52}}{\sqrt{1 + {ω}^{2} \cdot {( {C}_{52} )}^{2} \cdot {( {R}_{52} )}^{2}}} \qquad ( 13 )$$

A configuration of the second inspection signal generation circuit 350 is not limited to the examples illustrated in FIG. 7 and FIG. 10. For example, the second gain adjustment circuit 352 may be provided between the second filter circuit 354 and the second buffer circuit 356. Alternatively, a part or all of the second gain adjustment circuit 352 and the second buffer circuit 356 may be omitted from the second inspection signal generation circuit 350 illustrated in FIG. 10.

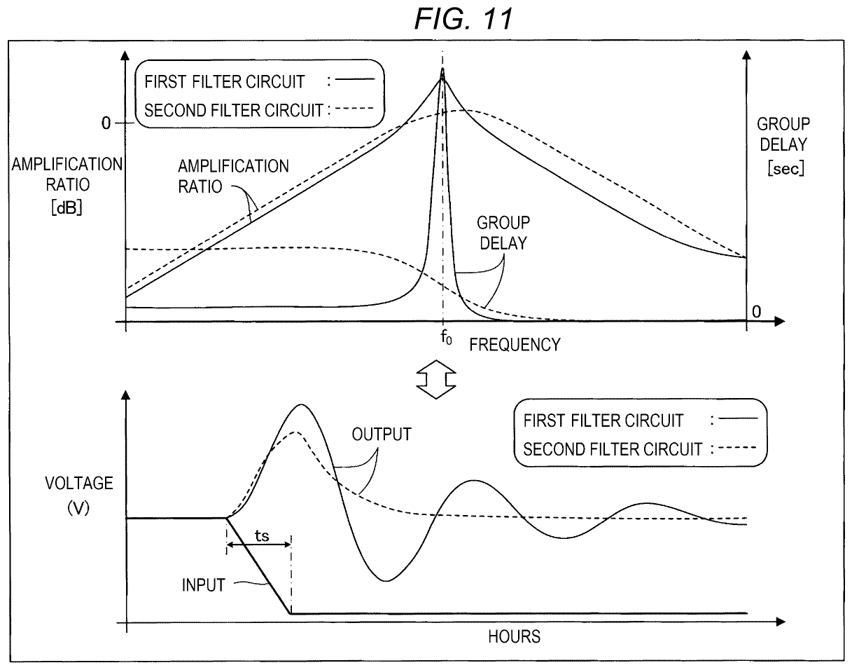

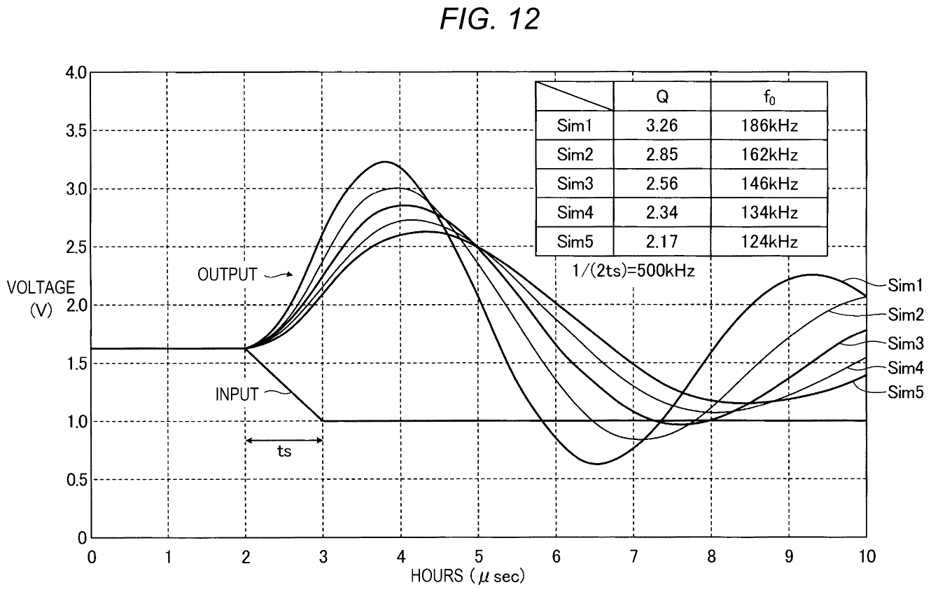

Subsequently, characteristics of the first filter circuit 344 is explained with reference to FIG. 11.

FIG. 11 is a diagram illustrating characteristics of the first filter circuit 344. An upper diagram of FIG. 11 illustrates a relationship between an amplification ratio and a group delay of the first filter circuit 344 and a frequency. A lower diagram of FIG. 11 illustrates a response of the first filter circuit 344 in the case in which a signal changing from the high level to the low level is input to the first filter circuit 344 having the characteristics illustrated in the upper diagram of FIG. 11. In FIG. 11, characteristics and the like of the second filter circuit 354 are indicated by broken lines as comparison targets of the first filter circuit 344.

As explained with reference to FIG. 9, the first filter circuit 344 is a multiple feedback type bandpass filter. As illustrated in the upper diagram of FIG. 11, the multiple feedback type bandpass filter has a characteristic that the group delay greatly changes near the center frequency f₀. A delay occurring near the center frequency f₀ means that a phase is rotated near the center frequency f₀. For example, when a group delay is represented as Tdg, a phase is represented as φ[rad], and an angular velocity is represented as ω[rad/sec], the group delay characteristic is represented by “Tdg (ω)=−dφ/dω”.

In the first filter circuit 344 in which the group delay greatly changes near the center frequency f₀, an overshoot occurs at the center frequency f₀. That is, a damped oscillation waveform occurs at the center frequency f₀. Accordingly, in the first filter circuit 344, as illustrated in a lower diagram of FIG. 11, a signal having a damped oscillation waveform is output even if an input signal is maintained at low level potential.

In contrast, the second filter circuit 354 does not have a characteristic that the group delay greatly changes near the center frequency f₀ as indicated by a broken line in the upper diagram of FIG. 11. In the second filter circuit 354, as indicated by a broken line in the lower diagram of FIG. 11, when the input signal is maintained at the low level potential, an output signal converges to predetermined potential.

In the present embodiment, the first filter output signal Obpf1, which is an output signal of the first filter circuit 344, can be treated as the pseudo residual vibration signal simulating the residual vibration of the discharge section D, by bringing the damped oscillation waveform generated at the center frequency f₀ close to a sinusoidal wave. A time ts illustrated in FIG. 11 is a time in which the potential of the first filter input signal INbpf1 input to the first filter circuit 344 changes from a maximum value to a minimum value. For example, in order to generate a damped oscillation waveform close to the sinusoidal wave, the center frequency f₀ is designed to be equal to or smaller than “1/(2ts)”.

Subsequently, a simulation result of the first filter circuit 344 is explained with reference to FIG. 12. FIG. 12 is a diagram illustrating the simulation result of the first filter circuit 344. FIG. 12 illustrates a simulation result of a response of the first filter circuit 344 in the case in which a signal changing from the high level to the low level is input. In a simulation illustrated in FIG. 12, the time ts in which the potential of a signal input to the first filter circuit 344 changes from a maximum value to a minimum value is 1 usec, and “1/(2 ts)” is 500 KHz.

A simulation result Sim1 indicates a simulation result of the first filter circuit 344 in the case in which the Q value is 3.26 and the center frequency f₀ is 186 kHz. A simulation result Sim2 indicates a simulation result of the first filter circuit 344 in the case in which the Q value is 2.85 and the center frequency f₀ is 162 kHz. A simulation result Sim3 indicates a simulation result of the first filter circuit 344 in the case in which the Q value is 2.56 and the center frequency f₀ is 146 kHz. A simulation result Sim4 indicates a simulation result of the first filter circuit 344 in the case in which the Q value is 2.34 and the center frequency f₀ is 134 kHz. A simulation result Sim5 indicates a simulation result of the first filter circuit 344 in the case in which the Q value is 2.17 and the center frequency f₀ is 124 kHz.

As illustrated in FIG. 12, when the center frequency f₀ is equal to or smaller than “1/(2ts)”, the output signal of the first filter circuit 344 is close to the sinusoidal wave. Although not illustrated in FIG. 12, when the center frequency f₀ is “1/ts”, it is confirmed that distortion occurs in the output signal of the first filter circuit 344 and a simulation result indicating that the output signal of the first filter circuit 344 cannot be regarded as the sinusoidal wave is obtained.

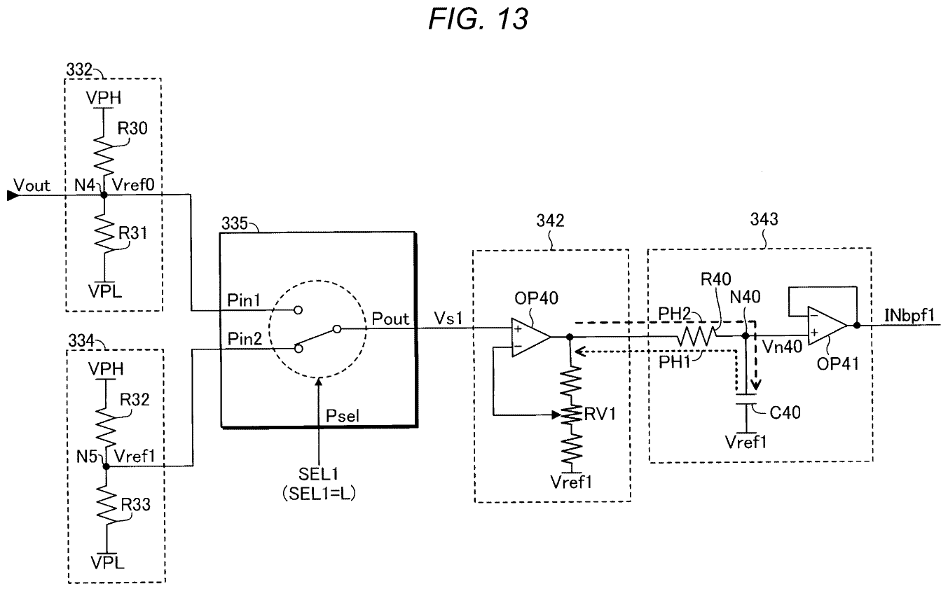

Subsequently, an operation of the low-pass filter circuit 343 at the time when the first input signal Vs1 has been switched from the detection signal Vout to the first reference potential Vref1 is briefly explained with reference to FIG. 13.

FIG. 13 is a diagram illustrating the operation of the low-pass filter circuit 343 at the time when the first input signal Vs1 has been switched from the detection signal Vout to the first reference potential Vref1.

For example, at a detection end time point when the first input signal Vs1 has been switched from the detection signal Vout to the first reference potential Vref1, potential Vn40 of the node N40 is retained at the potential of the output signal of the operational amplifier OP40 at the detection end time point by the capacitor C40. The potential Vn40 of the node N40 converges to the first reference potential Vref1 by a time constant of the low-pass filter circuit 343. For example, when the potential Vn40 of the node N40 at the detection end time point is higher than the first reference potential Vref1, the capacitor C40 is discharged to the first gain adjustment circuit 342 in a first path PH1. For example, when the potential Vn40 of the node N40 at the detection end time point is lower than the first reference potential Vref1, the capacitor C40 is charged from the first gain adjustment circuit 342 in a second path PH2.

The potential Vn40 of the node N40 after the detection end time point is represented by Expression (14) using the first reference potential Vref1, an elapsed time t from the detection end time point, a time constant t, and a potential difference ΔVn40 between the potential Vn40 at the detection end time point and the first reference potential Vref1.

$$V n 40 = Δ V n 40 * exp ( - t / τ ) + V ref 1 \qquad ( 14 )$$

In Expression (14), “exp ( )” indicates an exponential function. The potential difference ΔVn40 of Expression (14) is represented by Expression (15) using, for example, the potential Vn40 at the detection end time point and the first reference potential Vref1.

$$Δ V n 40 = V n 40 - V ref 1 \qquad ( 15 )$$

When output impedance of a circuit at a pre-stage of the low-pass filter circuit 343 is represented as Rp, the time constant t of Expression (14) is represented by Expression (16). In the present embodiment, the circuit at the pre-stage of the low-pass filter circuit 343 is the first gain adjustment circuit 342. Therefore, the output impedance Rp of Expression (16) indicates an output impedance of the first gain adjustment circuit 342.

$$τ = {C}_{40} ★ ( {R}_{40} + R p ) \qquad ( 16 )$$

When an output impedance of the operational amplifier OP40 is extremely smaller compared with the impedance of the variable resistor RV, the output impedance of the operational amplifier OP40 may be regarded as the output impedance of the first gain adjustment circuit 342.

For example, in a configuration in which the low-pass filter circuit 343 is coupled to the first switching circuit 335 not via the first gain adjustment circuit 342, the output impedance Rp of Expression (16) indicates the output impedance of the first reference potential generation circuit 334. In this case, the output impedance Rp is represented by Expression (17).

$$R p = ( {R}_{32} ★ {R}_{33} ) / ( {R}_{32} + {R}_{33} ) \qquad ( 17 )$$

For example, the low-pass filter circuit 343 is preferably designed such that a relationship between the time ts in which the potential of the detection signal Vout input to the first inspection signal generation circuit 340 as the first input signal Vs1 changes from the maximum value to the minimum value and the time constant t satisfies Expression (18).

$$ts / 2 \approx τ \sim 4.6 τ \qquad ( 18 )$$

“T” in Expression (18) corresponds to a time until the charging or discharging of the capacitor C40 reaches approximately 63%. “4.61” in Expression (18) corresponds to a time until the charging or discharging of the capacitor C40 reaches approximately 100%. Accordingly, Expression (18) means that a half time of the time ts is included in a range from the time until the charging or discharging of the capacitor C40 reaches approximately 63% to the time until the charging or discharging of the capacitor C40 reaches approximately 100% from.

Here, in the first filter circuit 344 in a post stage of the low-pass filter circuit 343, a circuit including the capacitor C41, the resistance element R42, and the operational amplifier OP42 functions as a differentiating circuit. For this reason, when noise is superimposed on the detection signal Vout input to the first inspection signal generation circuit 340 or when the detection signal Vout includes a steep potential change, distortion is likely to occur in the first filter output signal Obpf1 output from the first filter circuit 344. When distortion occurs in the first filter output signal Obpf1, it is likely that variation in an amplitude value and the like of the first inspection signal Vd1 generated as the pseudo residual vibration signal increases and determination accuracy of the state of the discharge section D is deteriorated. For this reason, in the present embodiment, the potential of the first input signal Vs1 in a non-detection period, which is a period in which the detection signal Vout is not input to the first inspection signal generation circuit 340, is stabilized to prevent distortion from occurring in the first filter output signal Obpf1. Specifically, in the present embodiment, the potential of the first input signal Vs1 in the non-detection period is converged to the first reference potential Vref1 by the first switching circuit 335 and the low-pass filter circuit 343 to prevent distortion from occurring in the first filter output signal Obpf1.

Subsequently, effects of the first switching circuit 335 and the low-pass filter circuit 343 are explained with reference to FIG. 14.

FIG. 14 is a diagram illustrating the effects of the first switching circuit 335 and the low-pass filter circuit 343. “Distortion countermeasure taken” in FIG. 14 indicates a simulation result of the first filter circuit 344 in the case in which the first switching circuit 335 and the low-pass filter circuit 343 are provided at a pre-stage of the first filter circuit 344. “Comparative example” in FIG. 14 indicates a simulation result of the first filter circuit 344 in the case in which the first switching circuit 335 and the low-pass filter circuit 343 are not provided at the pre-stage of the first filter circuit 344. However, in the comparative example, a switch that simply switches whether to electrically couple the switching circuit 31 and the detection circuit 33 is provided instead of the first switching circuit 335.

As illustrated in FIG. 14, in the comparative example in which the first switching circuit 335 and the low-pass filter circuit 343 are not provided, noise occurs in the first filter input signal INbpf1 in a period before the detection period Tdet1 begins. In the comparative example, the potential of the first filter input signal INbpf1 suddenly changes at the end time of the detection period Tdet1. For this reason, in the comparative example, distortion occurs in the first filter output signal Obpf1 in the period before the detection period Tdet1 begins and at the end time of the detection period Tdet1.

In contrast, in a configuration in which the first switching circuit 335 and the low-pass filter circuit 343 are provided, noise is prevented from occurring in the first filter input signal INbpf1 and the potential of the first filter input signal INbpf1 is prevented from suddenly changing. As a result, in the configuration in which the first switching circuit 335 and the low-pass filter circuit 343 are provided, distortion is prevented from occurring in the first filter output signal Obpf1.

As explained above, in the present embodiment, since distortion is prevented from occurring in the first filter output signal Obpf1, it is possible to prevent the amplitude value and the like of the first inspection signal Vd1 generated as the pseudo residual vibration signal from varying. As a result, in the present embodiment, it is possible to accurately determine the state of the discharge section D.

As illustrated in FIG. 14, the first filter circuit 344 can output the first filter output signal Obpf1 equal to or larger than one cycle based on the first filter input signal INbpf1 equal to or larger than quarter cycle and smaller than one cycle.

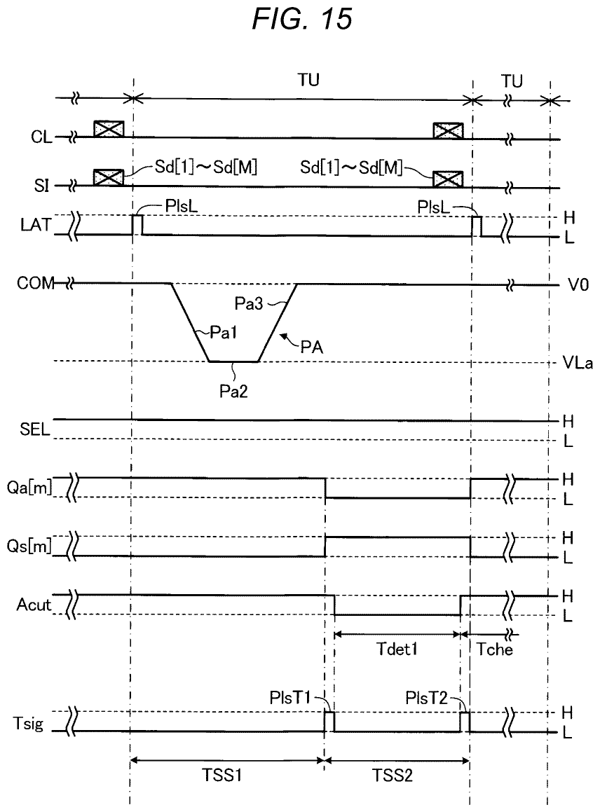

Subsequently, an operation of the inkjet printer 1 is explained with reference to FIG. 15.

FIG. 15 is a timing chart illustrating an example of the operation of the inkjet printer 1 in a unit period Tu. In the present embodiment, when the inkjet printer 1 executes the print processing or the discharge state determination processing, one or a plurality of unit periods TU are set as an operating period of the inkjet printer 1. The inkjet printer 1 according to the present embodiment can drive the discharge sections D[m] for the print processing or the discharge state determination processing in the unit periods TU. For example, when executing the discharge state determination processing, the inkjet printer 1 can drive the determination target discharge section D and detect the detection signal Vout[m] from the determination target discharge section D in the unit periods TU.

The control unit 2 outputs a latch signal LAT having a pulse PlsL. Accordingly, the control unit 2 defines the unit period TU as a period from a rising edge of the pulse PlsL to a rising edge of the next pulse PlsL.

The print signal SI includes, for example, M individual designation signals Sd[1] to SD[m] corresponding to the M discharge sections D[1] to D[m] in a one-to-one relation. An individual designation signal Sd[m] designates a drive mode of the discharge section D[m] in the unit periods TU when the inkjet printer 1 executes the print processing or the discharge state determination processing. For example, prior to the unit periods TU, the control unit 2 supplies the print signal SI including the individual designation signals Sd[1] to SD[m] to the connection state designation circuit 310 in synchronization with a clock signal CL. The connection state designation circuit 310 generates the connection state designation signals Qa[m] and Qs[m] based on the individual designation signal Sd[m] in the unit periods TU. The connection state designation circuit 310 generates the selection signal SEL and the detection period signal Acut based on at least a part of the print signal SI, the latch signal LAT, and the period defining signal Tsig.

For example, the discharge section D[m] is designated, in the unit period TU in which the print processing is executed, according to the individual designation signal Sd[m], as one of the discharge section D that forms dots and the discharge section D that does not form dots. For example, in the unit period TU in which the discharge state determination processing executed, according to the individual designation signal Sd[m], it is designated whether the discharge section D[m] is driven as the determination target discharge section D. In FIG. 15, the connection state designation signals Qa[m] and Qs[m] and the like in the case in which the discharge section D[m] is designated as the determination target discharge section D according to the individual designation signal Sd[m] in the unit period TU in which the discharge state determination processing is executed are illustrated. In FIG. 15, an operation of the inkjet printer 1 in the case in which the discharge state determination processing is executed is mainly explained.

When the discharge state determination processing is executed, for example, the control unit 2 outputs the period defining signal Tsig having a pulse PlsT1 and a pulse PlsT2. Accordingly, the control unit 2 divides the unit period TU into a control period TSS1 from the start of the pulse PlsL to the start of the pulse PlsT1 and a control period TSS2 from the start of the pulse PlsT1 to the start of the next pulse PlsL.

The connection state designation circuit 310 defines the detection period Tdet1 of the detection signal Vout[m] by controlling the detection period signal Acut. For example, the connection state designation circuit 310 sets the detection period signal Acut to the low level in response to the end of the pulse PlsT1, and sets the detection period signal Acut to the high level in response to the start of the pulse PlsT2. The time from the start to the end of the detection period Tdet1 corresponds to a time allocated to detection of residual vibration of the discharge section D. In FIG. 15, a detection period Tdet1 in the case in which the detection signal Vout[m] is supplied to the first inspection signal generation circuit 340 is illustrated. When the detection signal Vout[m] is supplied to the first inspection signal generation circuit 340, a pseudo residual vibration signal simulating residual vibration of the discharge section D[m] is generated in an inspection period Tche. In FIG. 15, it is assumed that the detection signal Vout[m] is supplied to the first inspection signal generation circuit 340. Therefore, the selection signal SEL is maintained at the high level.

The drive signal COM used in the discharge state determination processing has, for example, a pulse PA supplied to the wire La in the control period TSS1. The pulse PA used in the discharge state determination processing may be a pulse for not discharging ink from the nozzle N or may be a pulse for discharging ink from the nozzle N if the pulse PA is a pulse for causing vibration in the vibration plate 321. In the present embodiment, it is assumed that the pulse PA is the pulse for not discharging ink from the nozzle N. In the print processing, instead of the pulse PA, a pulse for discharging ink from the nozzle N is supplied to the wire line La in the unit period TU.

The pulse PA is a waveform in which the potential of the drive signal COM returns from the potential V0 to the potential V0 through a potential VLa lower than the potential V0. The potential V0 is a potential at the start time and the end time of the pulse PA and is a reference potential of the drive signal COM.

For example, the pulse PA includes a waveform element Pa1 in which the potential changes from the potential V0 to the potential VLa, a waveform element Pa2 in which the potential is maintained at the potential VLa at the end time of the waveform element Pa1, and a waveform element Pa3 in which the potential changes from the potential VLa to the potential V0. In the following explanation, the waveform elements Pa1, Pa2, and Pa3 are sometimes collectively referred to as waveform element Pa.

The waveform element Pa1 is an expansion element for displacing the piezoelectric body Zb in the Z2 direction. In the expansion element, the potential of the drive signal COM changes in order to drive the piezoelectric element PZ to expand the volume of the cavity CV. Therefore, in the waveform element Pa1, the potential of the drive signal COM changes to expand the volume of the cavity CV. When the volume of the cavity CV has expanded, the surface of the ink in the nozzle N is drawn in the Z2 direction, which is a direction opposite to the discharge direction, as in the state of Phase 2 illustrated in FIG. 4. In the following explanation, drawing the surface of the ink in the nozzle N in the direction opposite to the discharge direction is sometimes referred to as pull.

The waveform element Pa2 is a maintenance element for maintaining the position of the piezoelectric body Zb in the Z-axis direction. For example, in the waveform element Pa2, the potential of the drive signal COM is maintained in order to drive the piezoelectric element PZ to maintain the volume of the cavity CV expanded by the waveform element Pa1.

The waveform element Pa3 is a contraction element for displacing the piezoelectric body Zb in the Z1 direction. In the contraction element, the potential of the drive signal COM changes in order to drive the piezoelectric element PZ to contract the volume of the cavity CV. Therefore, in the waveform element Pa3, the potential of the drive signal COM changes to contract the volume of the cavity CV. When the volume of the cavity CV contracts, the surface of the ink in the nozzle N is pushed out in the Z1 direction, which is the discharge direction. In the present embodiment, the surface of the ink in the nozzle N is pushed out in the Z1 direction by the waveform element Pa3 to a degree in which the ink is not discharged from the nozzle N. In the following explanation, pushing the surface of the ink in the nozzle N in the discharge direction is sometimes referred to as push.

As explained above, the pulse PA is a so-called pull-push waveform. However, the waveform of the drive signal COM for not discharging the ink from the nozzle N is not limited to the pull-push waveform.

For example, when the discharge section D[m] is designated as the determination target discharge section D according to the individual designation signal Sd[m], the connection state designation circuit 310 sets the connection state designation signal Qa[m] to the high level and sets the connection state designation signal Qs[m] to the low level in the control period TSS1. In the control period TSS2, the connection state designation circuit 310 sets the connection state designation signal Qa[m] to the low level and sets the connection state designation signal Qs[m] to the high level.

When the control period TSS1 and the control period TSS2 are switched, the state of each of the switches SWa[m] and SWs[m] is preferably switched between ON and OFF via a state in which both the switches SWa[m] and SWs[m] are turned on. That is, timing when the connection state designation signal Qs[m] transitions from the low level to the high level is preferably timing before timing when the connection state designation signal Qa[m] transitions from the high level to the low level. Timing when the connection state designation signal Qs[m] transitions from the high level to the low level is preferably timing after timing when the connection designation signal Qa[m] transitions from the low level to the high level. In this case, when the control period TSS1 and the control period TSS2 are switched, a state in which both the switches SWa[m] and SWs[m] are turned off does not occur. Therefore, it is possible to prevent the potential of the node N2 illustrated in FIG. 6 from changing with switching noise or the like.

Timing when the detection period signal Acut transitions from the high level to the low level is preferably timing after timing when the connection state designation signal Qa[m] transitions from the high level to the low level and timing when the connection state designation signal Qs[m] transitions from the low level to the high level. Timing when the detection period signal Acut transitions from the low level to the high level is preferably timing before timing when the connection state designation signal Qa[m] transitions from the low level to the high level and timing when the connection state designation signal Qs[m] transitions from the high level to the low level. For this reason, in the present embodiment, as explained above, the connection state designation circuit 310 sets the detection period signal Acut to the low level at the opportunity of the end of the pulse PlsT1 and sets the detection period signal Acut to the high level at the opportunity of the start of the pulse PlsT2. If the transition timing explained above is satisfied, the connection state designation circuit 310 may set the detection period signal Acut to the low level at the opportunity of the start of the pulse PlsT1 and set the detection period signal Acut to the high level at the opportunity of the start of the next pulse PlsL.

By setting timing when the level of the detection period signal Acut is transitioned to satisfy the transition timing explained above, it is possible to prevent noise or the like from occurring in the first input signal Vs1 and the second input signal Vs2. When noise or the like that occurs in the first input signal Vs1 and the second input signal Vs2 is suppressed within an allowable range, the timing when the level of the detection period signal Acut is caused to transition may not satisfy the transition timing explained above.

The piezoelectric element PZ[m] provided in the determination target discharge section D[m] is driven by the pulse PA of the drive signal COM in the control period TSS1. Specifically, the piezoelectric element PZ[m] provided in the determination target discharge section D[m] is displaced from the pulse PA of the drive signal COM in the control period TSS1. As a result, vibration occurs in the determination target discharge section D[m]. The vibration occurring in the control period TSS1 remains in the control period TSS2 as well. In the control period TSS2, the potential of the upper electrode Zu[m] of the piezoelectric element PZ[m] provided in the determination target discharge section D[m] changes according to residual vibration occurring in the determination target discharge section D[m]. That is, in the control period TSS2, the potential of the upper electrode Zu of the piezoelectric element PZ provided in the determination target discharge section D is a potential corresponding to an electromotive force of the piezoelectric element PZ due to the residual vibration occurring in the determination target discharge section D. The potential of the upper electrode Zu is detected as the potential signal Vzu in the control period TSS2. Accordingly, the change in the potential of the upper electrode Zu is detected as the detection signal Vout in the control period TSS2. As a result, the detection signal Vout is input to the detection circuit 33 as a residual vibration signal generated according to the vibration remaining in the discharge section D.

The detection signal Vout input to the detection circuit 33 is supplied to the first inspection signal generation circuit 340 as the first input signal Vs1 in the detection period Tdet1 of the control period TSS2. Accordingly, in the inspection period Tche following the detection period Tdet1, the first inspection signal Vd1 is generated by the first inspection signal generation circuit 340 as a pseudo residual vibration signal simulating the residual vibration of the discharge section D[m].

Subsequently, an operation of the inkjet printer 1 in the case in which the print processing is executed is briefly explained. In the print processing, the unit period TU may not be divided into the control period TSS1 and the control period TSS2. In this case, in the unit period TU, the period defining signal Tsig may be maintained at the low level and the detection period signal Acut may be maintained at the high level.

The connection state designation signal Qs[m] is maintained at the low level in the unit period TU regardless of, for example, whether the discharge section D[m] is designated as the discharge section D that forms dots. The connection state designation signal Qa[m] is set to the high level or the low level according to whether the discharge section D[m] is designated as the discharge section D that forms dots.

For example, when the discharge section D[m] is designated by the individual designation signal Sd[m] as the discharge section D that forms dots, the connection state designation circuit 310 sets the connection state designation signal Qa[m] to the high level in the unit period TU. The connection state designation signal Qa corresponding to the discharge section D that does not form dots is set to the low level in the unit period TU.

The connection state designation signal Qa[m] is set to the high level, whereby the drive signal COM including a pulse for discharging the ink from the nozzle N is supplied from the drive signal generation unit 4 to the discharge section D that forms dots. For example, the pulse for discharging ink from the nozzle N is supplied to the wire La in the unit period TU. The pulse for discharging the ink from the nozzle N may be a pull-push waveform like the pulse PA. In this case, the pulse for discharging the ink from the nozzle N is determined such that a potential difference between the start time and the end time of the contraction element, which is a waveform element for discharging the ink, is larger than a potential difference between the start time and the end time of the waveform element Pa3 of the pulse PA. The pulse for discharging the ink from the nozzle N is not limited to the pull-push waveform. For example, the pulse for discharging the ink from the nozzle N may be a pull-push-pull waveform.

Waveform elements of the pulse for discharging ink from the nozzle N are determined such that a predetermined amount of ink is discharged from the discharge section D[m] when the individual drive signal Vin[m] having the pulse is supplied to the discharge section D[m]. In the present embodiment, it is assumed that, when the potential of the individual drive signal Vin[m] is high potential, the volume of the cavity CV provided in the discharge section D[m] is smaller compared with the volume in the case of low potential. Therefore, when the discharge section D[m] is driven by the individual drive signal Vin[m] having the pulse for discharging the ink, the ink in the discharge section D[m] is discharged from the nozzle N by a waveform element in which the potential of the individual drive signal Vin[m] changes from the low potential to the high potential.

For example, the waveform elements of the pulse for discharging the ink from the nozzle N are determined based on discharge characteristics of the ink by the discharge section D. The discharge characteristics of the ink are, for example, an amount of ink discharged as ink droplets and discharge speed of the discharged ink droplets. The discharge speed of the ink droplets changes according to, for example, the viscosity of the ink. For example, discharge speed of the ink droplets having higher viscosity than the predetermined viscosity decreases compared with discharge speed of the ink droplets having viscosity equal to or lower than the predetermined viscosity. As explained in detail below with reference to FIG. 16, in the present embodiment, a viscosity increased state of the ink in the discharge section D can be determined based on a pseudo residual vibration signal.

In the present embodiment, since it is assumed that the pulse PA is a pulse for not discharging the ink from the nozzle N, the discharge state determination processing can be executed even when the head unit 3 is not located on the discharged ink receiving section 80. For example, when printing is performed for each pass while the head unit 3 being move along the X-axis direction, the discharge state determination processing may be executed between a path and a path. The discharge state determination processing may be executed between a print job based on one print data IMG and a print job based on another print data IMG. Alternatively, the discharge state determination processing may be executed when the maintenance processing is executed.

The operation of the inkjet printer 1 is not limited to the example illustrated in FIG. 15. For example, the pulse PA may be the pulse for discharging the ink from the nozzle N. In this case, the drive signal COM including the pulse PA may be used in both of the print processing and the discharge state determination processing. However, when the pulse PA used in the discharge state determination processing is the pulse for discharging ink from the nozzle N, the discharge state determination processing is preferably executed in, for example, a state in which the head unit 3 is located on the discharged ink receiving section 80.

For example, when the discharge state determination processing is executed, the control unit 2 may output the period defining signal Tsig having only the pulse PlsT1 of the pulse PlsT1 and the pulse PlsT2. In this case, for example, the connection state designation circuit 310 may set the detection period signal Acut to the low level at the opportunity of the start or the end of the pulse PlsT1 and set the detection period signal Acut to the high level at the opportunity of the start of the next pulse PlsL to satisfy the transition timing explained above.

For example, in FIG. 15, the case in which one drive signal COM is used is exemplified. However, the present disclosure is not limited to such an aspect. For example, a plurality of drive signals COM including the drive signal COM for not discharging ink from the nozzle N and the drive signal COM for discharging ink from the nozzle N may be used. In this case, in the print processing, the pulse PA for not discharging the ink may be used to prevent viscosity increase of the ink. The drive signal COM for discharging the ink from the nozzles N may have a plurality of pulses for discharging, from the nozzles N, ink for forming dots of different sizes.

Subsequently, the first inspection signal Vd1 generated by the first inspection signal generation circuit 340 is explained with reference to FIG. 16.

FIG. 16 is a diagram illustrating an example of the first inspection signal Vd1 generated by the first inspection signal generation circuit 340. In FIG. 16, to facilitate understanding of explanation, any one of numbers 1, 2, and 3 is added to the end of a sign of each of a plurality of unit periods TU. In FIG. 16, it is assumed that a discharge section D[a] is designated as the determination target discharge section D in the unit period TU1 and a discharge section D[b] is designated as the determination target discharge section D in the unit period TU2. A value a is a natural number that satisfies “1≤a≤M” and a value b is a natural number that satisfies “1≤b≤M” and is different from the value a. The time ts is a time in which the potential of the detection signal Vout input to the first inspection signal generation circuit 340 changes from the maximum value to the minimum value or a time in which the potential of the detection signal Vout changes from the minimum value to the maximum value in the detection period Tdet1.

In the detection period Tdet1 in which the detection period signal Acut is at the low level, the detection signal Vout is input to the first inspection signal generation circuit 340 as the first input signal Vs1. For example, in a detection period Tdet1[a] of the unit period TU1, the detection signal Vout indicating residual vibration of the discharge section D[a] driven by an individual drive signal Vin[a] is input to the first inspection signal generation circuit 340 as the first input signal Vs1. Then, according to the end of the detection period Tdet1[a], the first input signal Vs1 is switched from the detection signal Vout to the first reference potential Vref1. Accordingly, in the inspection period Tche[a], the potential of the first input signal Vs1 converges to the first reference potential Vref1.

As illustrated in FIG. 16, the detection signal Vout input to the first inspection signal generation circuit 340 as the first input signal Vs1 is the detection signal Vout smaller than one cycle. For this reason, in the first inspection signal generation circuit 340, the length of the detection period Tdet1 can be reduced compared with the second inspection signal generation circuit 350 to which the detection signal Vout equal to or larger than one cycle is input as the second input signal Vs2. Accordingly, in the present embodiment, the unit period TU in the case in which the inspection signal VD is generated by the first inspection signal generation circuit 340 can be reduced compared with the unit period TU in the case in which the inspection signal VD is generated by the second inspection signal generation circuit 350.

In an inspection period Tche[a] following the detection period Tdet1[a], the wire Ls2 coupling the switching circuit 31 and the detection circuit 33 is electrically decoupled from the first inspection signal generation circuit 340. For this reason, even if an individual drive signal Vin[b] is supplied to the discharge section D[b] in the inspection period Tche[a], the first inspection signal generation circuit 340 can generate the first inspection signal Vd1 simulating an attenuation wave of the detection signal Vout indicating the residual vibration of the discharge section D[a].

For example, as explained with reference to FIG. 11, the first filter circuit 344 is a multiple feedback type bandpass filter having a characteristic that a group delay greatly changes near the center frequency f₀. For this reason, a damped oscillation waveform corresponding to the detection signal Vout occurs at the center frequency f₀. After the input of the detection signal Vout to the first filter circuit 344 ends, that is, after the end of the detection period Tdet1, the first filter output signal Obpf1 having the damped oscillation waveform occurring at the center frequency f₀ is output from the first filter circuit 344. Accordingly, for example, in the inspection period Tche[a], the first inspection signal Vd1 having a damped oscillation waveform corresponding to the detection signal Vout indicating the residual vibration of the discharge section D[a] is output from the first inspection signal generation circuit 340 to the inspection unit 6. For example, in the inspection period Tche[b], the first inspection signal Vd1 having an damped oscillation waveform corresponding to the detection signal Vout indicating the residual vibration of the discharge section D[b] is output from the first inspection signal generation circuit 340 to the inspection unit 6.

The inspection unit 6 determines a state of the discharge section D[a] based on the first inspection signal Vd1 output from the first inspection signal generation circuit 340 as the inspection signal VD[a] in the inspection period Tche[a]. The inspection unit 6 determines a state of the discharge section D[b] based on the first inspection signal Vd1 output from the first inspection signal generation circuit 340 as the inspection signal VD[b] in the inspection period Tche[b]. The inspection unit 6 may determine the state of the discharge section D based on the first inspection signal Vd1 output from the first inspection signal generation circuit 340 as the inspection signal VD in a period including the detection period Tdet1 and the inspection period Tche. That is, the inspection unit 6 may determine the state of the discharge section D based on the first inspection signal Vd1 output from the first inspection signal generation circuit 340 in the inspection period Tche and the first inspection signal Vd1 output from the first inspection signal generation circuit 340 in the detection period Tdet1.

In the example illustrated in FIG. 16, a solid line waveform of the first input signal Vs1 indicates a waveform of the first input signal Vs1 in the case in which the state of the discharge section D is normal and a broken line waveform of the first input signal Vs1 indicates a waveform of the first input signal Vs1 in the case in which the ink in the discharge section D is in the viscosity increased state. Similarly, a solid line waveform of the inspection signal VD indicates a waveform of the inspection signal VD in the case in which the state of the discharge section D is normal and a broken line waveform of the inspection signal VD indicates a waveform of the inspection signal VD in the case in which the ink in the discharge section D is in the viscosity increased state. As illustrated in FIG. 16, the amplitude of the inspection signal VD is different between a case in which the state of the discharge section D is normal and a case in which the ink in the discharge section D is in the viscosity increased state.

For example, the amplitude of the inspection signal VD in the case in which the ink in the discharge section D is in the viscosity increased state is smaller than the amplitude of the inspection signal VD in the case in which the state of the discharge section D is normal. A difference dA11 in FIG. 16 indicates the difference between the amplitude of a first peak of the inspection signal VD in the inspection period Tche in the case in which the state of the discharge section D is normal and the amplitude of a first peak of the inspection signal VD in the inspection period Tche in the case in which the ink in the discharge section D is in the viscosity increased state. A difference dA21 in FIG. 16 indicates the difference between the amplitude of a second peak of the inspection signal VD in the inspection period Tche in the case in which the state of the discharge section D is normal and the amplitude of a second peak of the inspection signal VD in the inspection period Tche in the case in which the ink in the discharge section D is in the viscosity increased state.

It is confirmed by a simulation by a discloser that a rate of change of the amplitude of the inspection signal VD between the case in which the state of the discharge section D is normal and the case in which the ink inside the discharge section D is in the viscosity increased state is substantially the same result as the case in which the second inspection signal Vd2 is used as the inspection signal VD. For example, in a simulation in the case in which the first: inspection signal Vd1 is used as the inspection signal VD, a rate of change calculated based on the difference dA11, that is, a rate of change of the amplitude of the first peak of the inspection signal VD in the inspection period Tche is 43%. A simulation result of a rate of change calculated based on the difference dA21, that is, a simulation result of a rate of change of the amplitude of the second peak of the inspection signal VD in the inspection period Tche is 54%. In contrast, in a simulation in the case in which the second inspection signal Vd2 is used as the inspection signal VD, a rate of change calculated based on a difference dA12 illustrated in FIG. 17 is 36% and a rate of change calculated based on a difference dA22 illustrated in FIG. 17 is 50%. The first peak of the inspection signal VD in the inspection period Tche corresponds to the second peak of the inspection signal VD in a period including the detection period Tdet1 and the inspection period Tche. For this reason, the differences dA12 and dA22 illustrated in FIG. 17 respectively correspond to the differences dA11 and dA21.

As explained above, also when the first inspection signal Vd1 is used as the inspection signal VD, the state of the discharge section D can be determined based on a rate of change of the amplitude of the inspection signal VD with respect to a reference amplitude value. The reference amplitude value is determined in advance, for example, based on the amplitude of the inspection signal VD in the case in which the state of the discharge section D is normal.

A method of specifying the amplitude of the inspection signal VD is not particularly limited, and a known method can be adopted. For example, the inspection unit 6 may compare a plurality of thresholds different from one another and the potential of the inspection signal VD, generate a plurality of pulses each indicating a comparison result between the plurality of thresholds and the potential of the inspection signal VD, and specify the amplitude of the inspection signal VD based on the widths of the generated plurality of pulses. A pulse indicating a comparison result between the threshold and the potential of the inspection signal VD is, for example, a pulse that is at the high level in a period in which the potential of the inspection signal VD is equal to or more than the threshold. When the inspection unit 6 includes, for example, a comparator that compares the plurality of thresholds and the potential of the inspection signal VD, the comparator may be provided in the head unit 3. In this case, the inspection unit 6 includes the comparator provided in the head unit 3 and an element provided on the outside of the head unit 3.

As explained above, in the present embodiment, a part or all of the inspection period Tche[a] for generating the first inspection signal Vd1 corresponding to the residual vibration of the discharge section D[a] can be overlapped with the control period TSS1 for driving the discharge section D[b] different from the discharge section D[a]. Therefore, in the present embodiment, by using the first inspection signal Vd1 as the inspection signal VD for determining the state of the discharge section D, it is possible to reduce a time required to determine states of the plurality of discharge sections D including the discharge section D[a] and the discharge section D[b].

Subsequently, the second inspection signal Vd2 generated by the second inspection signal generation circuit 350 is explained with reference to FIG. 17.

FIG. 17 is a diagram illustrating an example of the second inspection signal Vd2 generated by the second inspection signal generation circuit 350. In FIG. 17, to facilitate understanding of explanation, one of numbers 1 and 2 is added to the end of a sign of each of a plurality of unit periods TU. In FIG. 17, it is assumed that the discharge section D[a] is designated as the determination target discharge section D in the unit period TU1. A value a is a natural number satisfying “1≤a≤M”. In FIG. 17, the detection period Tdet1 in the case in which the first inspection signal Vd1 is used as the inspection signal VD is indicated by a broken line arrow.

In the detection period Tdet2 that is a period in which the detection period signal Acut is at the low level, the detection signal Vout is input to the second inspection signal generation circuit 350 as the second input signal Vs2. For example, in a detection period Tdet2[a] of the unit period TU1, the detection signal Vout indicating residual vibration of the discharge section D[a] driven by the individual drive signal Vin[a] is input to the second inspection signal generation circuit 350 as the second input signal Vs2. Then, according to the end of the detection period Tdet2[a], the second input signal Vs2 is switched from the detection signal Vout to the second reference potential Vref2. Accordingly, in the control period TSS1 of the unit period TU2, the potential of the second input signal Vs2 converges to the second reference potential Vref2.

As illustrated in FIG. 17, the detection signal Vout input to the second inspection signal generation circuit 350 as the second input signal Vs2 is the detection signals Vout equal to or larger than one cycle. For this reason, in the second inspection signal generation circuit 350, the detection period Tdet2 is longer compared with the detection period Tdet1 in the case in which the first inspection signal Vd1 is used as the inspection signal VD. As explained with reference to FIG. 10, the second filter circuit 354 is the bandpass filter that allow a signal of a predetermined frequency component to pass. For this reason, the second filter output signal Obpf2 obtained by removing frequency components other than the predetermined frequency component from the second filter input signal INbpf2 obtained by adjusting the amplitude of the detection signal Vout is output from the second filter circuit 354. Accordingly, for example, in the detection period Tdet2[a], the second inspection signal Vd2 obtained by removing frequency components other than the predetermined frequency component from a signal corresponding to the detection signal Vout indicating the residual vibration of the discharge section D[a] is output from the second inspection signal generation circuit 350 to the inspection unit 6.

In the detection period Tdet2[a], the wire Ls2 that couples the switching circuit 31 and the detection circuit 33 is electrically coupled to the second inspection signal generation circuit 350. For this reason, when the state of the discharge section D[a] is determined based on the second inspection signal Vd2, it is preferable not to drive the other discharge sections D until the detection period Tdet2[a] ends, that is, until the generation of the second inspection signal Vd2 is completed.

As explained above, in the detection period Tdet2[a], the second inspection signal generation circuit 350 generates the second inspection signal Vd2 based on the detection signal Vout equal to or larger than one cycle. For this reason, in the detection period Tdet2[a], the inspection unit 6 determines the state of the discharge section D[a] based on the second inspection signal Vd2 output from the second inspection signal generation circuit 350 as the inspection signal VD[a].

In the example illustrated in FIG. 17, a solid line waveform of the second input signal Vs2 indicates a waveform of the second input signal Vs2 in the case in which the state of the discharge section D is normal and a broken line waveform of the second input signal Vs2 indicates a waveform of the second input signal Vs2 in the case in which the ink in the discharge section D is in the viscosity increased state. Similarly, a solid line waveform of the inspection signal VD indicates a waveform of the inspection signal VD in the case in which the state of the discharge section D is normal and a broken line waveform of the inspection signal VD indicates a waveform of the inspection signal VD in the case in which the ink in the discharge section D is in the viscosity increased state. Also when the inspection signal VD is generated by the second inspection signal generation circuit 350, as illustrated in FIG. 17, the amplitude of the inspection signal VD is different between a case in which the state of the discharge section D is normal and a case in which the ink in the discharge section D is in the viscosity increased state.

For example, the amplitude of the inspection signal VD in the case in which the ink in the discharge section D is in the viscosity increased state is smaller than the amplitude of the inspection signal VD in the case in which the state of the discharge section D is normal. The difference dA12 in FIG. 17 indicates the difference between the amplitude of a second peak of the inspection signal VD in the detection period Tdet2 in the case in which the state of the discharge section D is normal and the amplitude of the second peak of the inspection signal VD in the case in which the ink in the discharge section D is in the viscosity increased state. The difference dA22 in FIG. 17 indicates the difference between the amplitude of a third peak of the inspection signal VD in the detection period Tdet2 in the case in which the state of the discharge section D is normal and the amplitude of the third peak of the inspection signal VD in the detection period Tdet2 in the case in which the ink in the discharge section D is in the viscosity increased state.

The second peak of the inspection signal VD in the detection period Tdet2 illustrated in FIG. 17 corresponds to the first peak of the inspection signal VD in the inspection period Tche illustrated in FIG. 16. The third peak of the inspection signal VD in the detection period Tdet2 illustrated in FIG. 17 corresponds to the second peak of the inspection signal VD in the inspection period Tche illustrated in FIG. 16.

As explained above, also when the second inspection signal Vd2 is used as the inspection signal VD, the state of the discharge section D can be determined based on a rate of change of the amplitude of the inspection signal VD with respect to the reference amplitude value as in the case in which the first inspection signal Vd1 is used as the inspection signal VD.

As explained above, the second inspection signal Vd2 is generated based on the detection signal Vout equal to or larger than one cycle. For this reason, in the present embodiment, the state of the discharge section D may be determined based on a part or all of the amplitude, the cycle, and the phase of the second inspection signal Vd2. In the present embodiment, it is possible to determine, based on the second inspection signal Vd2 generated based on the detection signal Vout equal to or larger than one cycle, a plurality of state abnormalities including the viscosity increased state of the ink in the discharge section D. Examples of the state abnormalities other than the viscosity increased state of the ink in the discharge section D include a state in which a discharge abnormality occurs because air bubbles are mixed in the cavity CV of the discharge section D and a state in which a discharge abnormality occurs because foreign matters adhere to the vicinity of the nozzle N of the discharge section D. For example, the determination of the state of the discharge section D in the second mode for determining the state of the discharge section D based on the second inspection signal Vd2 is effective when it is desired to accurately know a cause of a discharge abnormality.

The determination of the state of the discharge section D in the first mode for determining the state of the discharge section D based on the first inspection signal Vd1 is effective, since the unit period TU can be reduced compared with the second mode, when the state of the discharge section D is determined in the short time. For example, immediately after the start of the inkjet printer 1, the ink inside the cavity CV is in a stagnant state and is highly likely to be increased in viscosity. For this reason, the determination of the state of the discharge section D in the first mode may be performed preferentially over the determination of the state of the discharge section D in the second mode after the start of the inkjet printer 1. In this case, it is possible to prevent a time required to determine the state of the discharge section D from increasing after the start of the inkjet printer 1. As explained above, in the present embodiment, a mode in determining the state of the discharge section D can be switched according to a purpose of determining the state of the discharge section D, a scene in which the determination is performed, and the like. For example, the first mode may be a mode for determining the viscosity increased state of the ink in the discharge section D based on the first inspection signal Vd1. The second mode may be a mode for determining a plurality of state abnormalities including the viscosity increased state of the ink in the discharge section D based on the second inspection signal Vd2.

As explained above, in the present embodiment, the inkjet printer 1 includes the head unit 3, the drive signal generation unit 4 that generates the drive signal COM, and the inspection unit 6 that determines the state of the discharge section D based on the pseudo residual vibration signal. The head unit 3 includes the discharge section D including the nozzle N, the piezoelectric element PZ driven by the drive signal COM, and the cavity CV that discharges the ink from the nozzle N according to the driving of the piezoelectric element PZ, the first inspection signal generation circuit 340 that receives input of a residual vibration signal generated according to vibration remaining in the discharge section D after the piezoelectric element PZ is driven and generates a pseudo residual vibration signal corresponding to the residual vibration signal as a signal for determining a state of the discharge section D, and the first switching circuit 335 that switches whether to supply the residual vibration signal to the first inspection signal generation circuit 340. In the present embodiment, for example, the detection signal Vout is input to the first inspection signal generation circuit 340 as the residual vibration signal and the first inspection signal generation circuit 340 generates the first inspection signal Vd1 as the pseudo residual vibration signal.

As explained above, in the present embodiment, the pseudo residual vibration signal corresponding to the residual vibration signal is generated by the first inspection signal generation circuit 340 as the signal for determining the state of the discharge section D. For example, in the present embodiment, the first switching circuit 335 switches whether to supply the residual vibration signal to the first inspection signal generation circuit 340 such that the residual vibration signal smaller than one cycle is supplied to the first inspection signal generation circuit 340. Therefore, it is possible to reduce a time allocated to the detection of the residual vibration signal. That is, in the present embodiment, by generating the pseudo residual vibration signal based on the residual vibration signal smaller than one cycle, it is possible to reduce the time allocated to the detection of the residual vibration signal compared with when the state of the discharge section D is determined using the residual vibration signal equal to or larger than one cycle. Therefore, in the present embodiment, when the state of the discharge section D is determined, it is possible to prevent the length of the unit period TU, which is the cycle for driving the discharge section D, from increasing. That is, it is possible to reduce the length of the unit period TU in the case in which the state of the discharge section D is determined.

In the present embodiment, the first switching circuit 335 includes the first input terminal Pin1 to which the residual vibration signal is input, the second input terminal Pin2 to which the first reference potential Vref1 is supplied, and the output terminal Pout coupled to the first inspection signal generation circuit 340. Whether to make the first input terminal Pin1 and the output terminal Pout conducive or to make the second input terminal Pin2 and the output terminal Pout conductive is switched according to the input selection signal SEL 1. As explained above, in the present embodiment, the constant potential is supplied to the first inspection signal generation circuit 340 instead of the residual vibration signal in the non-detection period that is the period in which the residual vibration signal is not input to the first inspection signal generation circuit 340. Accordingly, in the present embodiment, it is possible to prevent noise and the like from occurring in the residual vibration signal used by the first inspection signal generation circuit 340 to generate the pseudo residual vibration signal. As a result, in the present embodiment, distortion is prevented from occurring in the pseudo residual vibration signal generated by the first inspection signal generation circuit 340.

In the present embodiment, the first inspection signal generation circuit 340 starts outputting the pseudo residual vibration signal after the state of being coupled to the second input terminal Pin2 via the output terminal Pout is switched to the state of being coupled to the first input terminal Pin1 via the output terminal Pout. Accordingly, in the present embodiment, it is possible to prevent the pseudo residual vibration signal in which the distortion has occurred from being used for the determination of the state of the discharge section D.

In the present embodiment, the first inspection signal generation circuit 340 includes the low-pass filter circuit 343 and the first filter circuit 344 that receives input of the residual vibration signal via the low-pass filter circuit 343 and generates the pseudo residual vibration signal. Accordingly, in the present embodiment, the first filter circuit 344 can generate the pseudo residual vibration signal based on the residual vibration signal from which noise and the like are removed. As a result, in the present embodiment, it is possible to prevent distortion from occurring in the pseudo residual vibration signal.

In the present embodiment, the inspection unit 6 determines the viscosity increased state of the ink in the discharge section D based on the pseudo residual vibration signal. That is, the pseudo residual vibration signal is used to determine the viscosity increased state of the ink in the discharge section D. Therefore, in the present embodiment, it is possible to prevent a time required for the determination of the viscosity increased state of the ink in the discharge section D from increasing. For example, in the present embodiment, it is possible to reduce a time required to determine the viscosity increased state of the ink in the plurality of discharge sections D.

### 2. Modifications

The aspects explained above can variously be modified. Specific aspects of modifications are exemplified below. Two or more aspects optionally selected out of the following exemplifications can be combined as appropriate within a range where the aspects are mutually consistent. Note that in the modifications exemplified below, elements having action and functions equivalent to those of the embodiment are denoted by the reference numerals and signs referred to in the above explanation and detailed explanation thereof is omitted as appropriate.

### First Modification

In the embodiment explained above, a part of the elements of the first filter circuit 344 may also be shared with the second filter circuit 354.

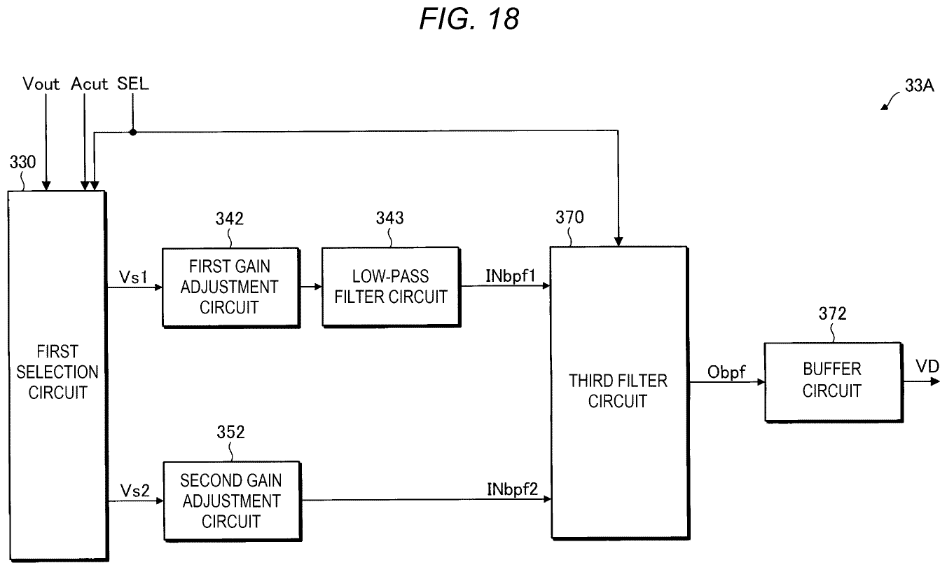

FIG. 18 is a block diagram illustrating an example of a configuration of a detection circuit 33A according to a first modification. The same elements as the elements explained with reference to FIGS. 1 to 17 are denoted by the same reference numerals and signs, and detailed explanation of the elements is omitted.

The inkjet printer 1 according to the present modification is the same as the inkjet printer 1 illustrated in FIG. 1 except that the inkjet printer according to the present modification includes the detection circuit 33A illustrated in FIG. 18 instead of the detection circuit 33 illustrated in FIG. 1. The detection circuit 33A includes, for example, the first selection circuit 330, the first gain adjustment circuit 342, the low-pass filter circuit 343, the second gain adjustment circuit 352, a third filter circuit 370, and a buffer circuit 372.

The first selection circuit 330, the first gain adjustment circuit 342, the low-pass filter circuit 343, and the second gain adjustment circuit 352 are respectively the same as the first gain adjustment circuit 342, the low-pass filter circuit 343, and the second gain adjustment circuit 352 illustrated in FIG. 7. However, the first filter input signal INbpf1, which is the output signal of the low-pass filter circuit 343, and the second filter input signal INbpf2, which is the output signal of the second gain adjustment circuit 352, are input to the third filter circuit 370.

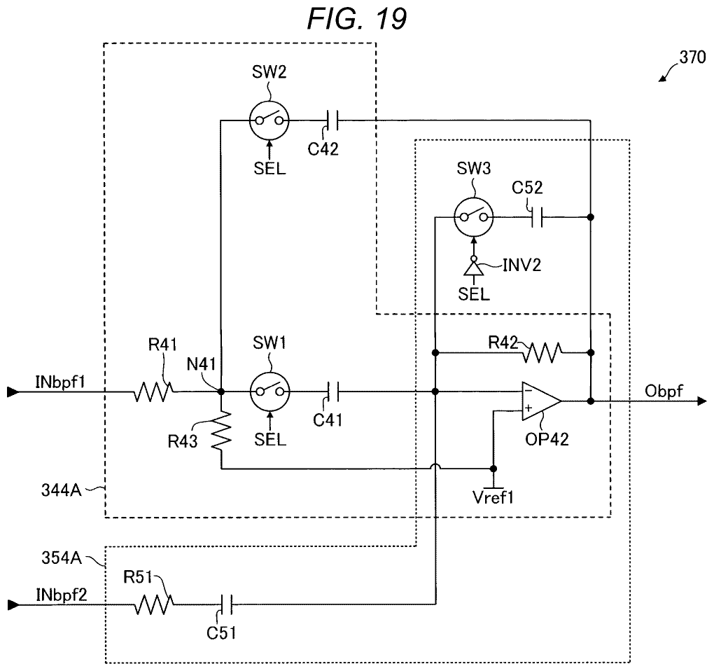

The third filter circuit 370 is, for example, a filter circuit that is switched based on the selection signal SEL to function as the first filter circuit 344 illustrated in FIG. 9 or to function as the second filter circuit 354 illustrated in FIG. 10. For example, the third filter circuit 370 functions as the first filter circuit 344 when the selection signal SEL is at the high level and functions as the second filter circuit 354 when the selection signal SEL is at the low level. As explained in detail below with reference to FIG. 19, in the third filter circuit 370, a part of the plurality of elements of the first filter circuit 344 and the plurality of elements of the second filter circuit 354 are shared by the first filter circuit 344 and the second filter circuit 354.

An output signal of the third filter circuit 370 is supplied to the buffer circuit 372 as a filter output signal Obpf.

The buffer circuit 372 is a buffer that converts impedance and outputs the low impedance inspection signal VD. For example, like the first buffer circuit 346 illustrated in FIG. 9, the buffer circuit 372 includes a voltage follower using the operational amplifier OP43. Accordingly, the filter output signal Obpf supplied to the buffer circuit 372 is output from the buffer circuit 372 as the low impedance inspection signal VD.

Subsequently, an overview of the third filter circuit 370 is explained with reference to FIG. 19.

FIG. 19 is a circuit diagram illustrating an example of a configuration of the third filter circuit 370 according to the first modification. The same elements as the elements explained with reference to FIGS. 1 to 18 are denoted by the same reference numerals and signs, and detailed explanation of the elements is omitted.

A first filter circuit 344A illustrated in FIG. 19 corresponds to the first filter circuit 344 illustrated in FIG. 9. A second filter circuit 354A illustrated in FIG. 19 corresponds to the second filter circuit 354 illustrated in FIG. 10. As illustrated in FIG. 19, in the third filter circuit 370, the operational amplifier OP42 and the resistance element R42 are shared by the first filter circuit 344A and the second filter circuit 354A. When the third filter circuit 370 functions as the second filter circuit 354A, the operational amplifier OP42 and the resistance element R42 respectively correspond to the operational amplifier OP51 and the resistance element R52 illustrated in FIG. 10.

The third filter circuit 370 includes, for example, the resistance elements R41, R42, R43, and R51, the capacitors C41, C42, and C52, the operational amplifier OP42, switches SW1, SW2, and SW3, and an inverter INV2.

One end of the resistance element R41 is coupled to the output terminal of the operational amplifier OP41 of the low-pass filter circuit 343 and the other end of the resistance element R41 is coupled to the node N41. One end of the capacitor C41 is coupled to the node N41 via the switch SW1. The other end of the capacitor C41 is coupled to the inverting input terminal of the operational amplifier OP42. One end of the resistance element R42 is coupled to the inverting input terminal of the operational amplifier OP42 and the other end of the resistance element R42 is coupled to the output terminal of the operational amplifier OP42. One end of the resistance element R43 is coupled to the node N41 and the other end of the resistance element R43 is coupled to the wire to which the first reference potential Vref1 is supplied. One end of the capacitor C42 is coupled to the node N41 via the switch SW2 and the other end of the capacitor C42 is coupled to the output terminal of the operational amplifier OP42. The non-inverting input terminal of the operational amplifier OP42 is coupled to the wire to which the first reference potential Vref1 is supplied.

One end of the resistance element R51 is coupled to the output terminal of the operational amplifier OP50 of the second gain adjustment circuit 352. The other end of the resistance element R51 is coupled to one end of the capacitor C51. The other end of the capacitor C51 is coupled to the inverting input terminal of the operational amplifier OP42. One end of the capacitor C52 is coupled to the inverting input terminal of the operational amplifier OP42 via the switch SW3. The other end of the capacitor C52 is coupled to the output terminal of the operational amplifier OP42.

The inverter INV2 outputs, to the switch SW3, an inverted signal of the selection signal SEL supplied from the connection state designation circuit 310.

The switch SW1 is turned on when the selection signal SEL is at the high level, electrically couples the capacitor C41 and the node N41, is turned off when the selection signal SEL is at the low level, and electrically decouples the capacitor C41 and the node N41. The switch SW2 is turned on when the selection signal SEL is at the high level, electrically couples the capacitor C42 and the node N41, is turned off when the selection signal SEL is at the low level, and electrically decouples the capacitor C42 and the node N41. The switch SW3 is turned on when the selection signal SEL is at the low level, electrically couples the capacitor C52 and the inverting input terminal of the operational amplifier OP42, is turned off when the selection signal SEL is at the low level, and electrically decouples the capacitor C52 and the inverting input terminal of the operational amplifier OP42.

For example, when the selection signal SEL is at the high level, the second filter input signal INbpf2 is maintained at constant potential and the first filter input signal INbpf1 is input to the inverting input terminal of the operational amplifier OP42 via the resistance element R41, the switch SW1, and the capacitor C41. Then, an output signal of the operational amplifier OP42 is fed back to the inverting input terminal of the operational amplifier OP42 via the resistance element R42. The output signal of the operational amplifier OP42 is fed back to the inverting input terminal of the operational amplifier OP42 via the capacitor C42, the switch SW2, the switch SW1, and the capacitor C41. As explained above, when the selection signal SEL is at the high level, the third filter circuit 370 functions as the same multiple feedback type bandpass filter as the first filter circuit 344 illustrated in FIG. 9.

For example, when the selection signal SEL is at the low level, the first filter input signal INbpf1 is maintained at constant potential and the second filter input signal INbpf2 is input to the inverting input terminal of the operational amplifier OP42 via the resistance element R51 and the capacitor C51. Then, an output signal of the operational amplifier OP42 is fed back to the inverting input terminal of the operational amplifier OP42 via the resistance element R42. The output signal of the operational amplifier OP42 is fed back to the inverting input terminal of the operational amplifier OP42 via the capacitor C52 and the switch SW3. As explained above, when the selection signal SEL is at the low level, the third filter circuit 370 functions as the same bandpass filter as the second filter circuit 354 illustrated in FIG. 10.

As explained above, in the present modification as well, the same effects as the effects of the embodiment explained above can be obtained. In the present modification, the operational amplifier OP42 and the resistance element R42 are shared by the first filter circuit 344A and the filter second circuit 354A. Accordingly, in the present modification, a circuit size of the detection circuit 33A can be reduced compared with the detection circuit 33.

### Second Modification

In the embodiment explained above, the first buffer circuit 346 may be omitted from the first inspection signal generation circuit 340, the second buffer circuit 356 may be omitted from the second inspection signal generation circuit 350, and the buffer circuit 372 may be provided at a post stage of the second selection circuit 360. Alternatively, the first gain adjustment circuit 342, the first buffer circuit 346, the second gain adjustment circuit 352, and the second buffer circuit 356 may be omitted and the same gain adjustment circuit as the first gain adjustment circuit 342 and the buffer circuit 372 may be provided at the post stage of the second selection circuit 360. In the modification explained above, the first gain adjustment circuit 342 and the second gain adjustment circuit 352 may be omitted and the same gain adjustment circuit as the first gain adjustment circuit 342 may be provided between the second selection circuit 360 and the buffer circuit 372.

As explained above, the present modification as well, the same effects as the effects of the embodiment and the modification explained above can be obtained. In the present modification, since the first buffer circuit 346 and the like are omitted, a circuit size of the detection circuit 33 or 33A can be reduced.

### Third Modification

In the embodiment and the modifications explained above, the second inspection signal generation circuit 350 may be omitted. For example, the second reference potential generation circuit 336, the second switching circuit 337, and the NOR circuit NOR2 provided in the first selection circuit 330, the second inspection signal generation circuit 350, and the second selection circuit 360 may be omitted from the detection circuit 33. In the present modification as well, the same effects as the effects of the embodiment and the modifications explained above can be obtained except the effects obtained by switching the mode when determining the state of the discharge section D.

### Fourth Modification

In the embodiment and the modifications explained above, in one printing operation, the number of times the state of the discharge section D is determined in the first mode may be larger than the number of times the state of the discharge section D is determined in the second mode. In the present modification as well, the same effects as the effects of the embodiment and the modifications explained above can be obtained. In the first mode, since the time allocated to the detection of the residual vibration of the discharge section D can be reduced, even if the number of times the state of the discharge section D is determined in the first mode is large, deterioration of the printing efficiency is not greatly affected.

### Fifth Modification

In the embodiment and the modifications explained above, a case in which the first inspection signal Vd1 indicating the pseudo residual vibration signal is generated based on the residual vibration equal to or larger than a quarter cycle and smaller than one cycle of the discharge section D is exemplified. However, the present disclosure is not limited to such an aspect. For example, the first inspection signal Vd1 may be generated based on the residual vibration of one cycle of the discharge section D and the second inspection signal Vd2 may be generated based on the residual vibration longer than one cycle of the discharge section D. In the present modification as well, the same effects as the effects of the embodiment and the modifications explained above can be obtained.

### Sixth Modification

In the embodiment and the modifications explained above, a case in which the piezoelectric element PZ is displaced in the Z1 direction when the potential of the individual drive signal Vin[m] changes from the low potential to the high potential is exemplified. However, the present disclosure is not limited to such an aspect. For example, the piezoelectric element PZ that is displaced in the Z1 direction when the potential of the individual drive signal Vin[m] changes from the high potential to the low potential may be used. In this case, for example, the potential of the drive signal COM changes from the low potential to the high potential in a portion corresponding to the expansion element and changes from the high potential to the low potential in a portion corresponding to the contraction element. In the present modification as well, the same effects as the effects of the embodiment and the modifications explained above can be obtained.

### Seventh Modification

In the embodiment and the modifications explained above, a case in which each of the head units 3 includes one nozzle row NL is exemplified. However, the present disclosure is not limited to such an aspect. For example, each of the head unit 3 may include a plurality of nozzle rows NL. In the present modification as well, the same effects as the effects of the embodiment and the modifications explained above can be obtained.

### Eighth Modification

In the embodiment and the modifications explained above, a case in which the inkjet printer 1 includes the four head units 3 is exemplified. However, the present disclosure is not limited to such an aspect. For example, the inkjet printer 1 may include one or more and three or less head units 3 or may include five or more head units 3. Alternatively, the inkjet printer 1 may include one or more and three or less head units 3A or may include five or more head units 3A.

### Ninth Modification

In the embodiment and the modifications explained above, a case in which the first filter circuit 344 is the multiple feedback type bandpass filter is exemplified. However, the present disclosure is not limited to such an aspect. For example, a filter circuit in which group delay characteristics change such as a Butterworth type and a Chebyshev type may be used as the first filter circuit 344. In the present modification as well, the same effects as the effects of the embodiment and the modifications explained above can be obtained.

### 3. Appendixes

From the embodiment exemplified above, for example, the following configurations are grasped.

According to a first aspect, which is a preferred aspect, there is provided a liquid discharge device including: a drive signal generation section configured to generate a drive signal; a discharge section including a nozzle, a piezoelectric element driven by the drive signal, and a pressure chamber configured to discharge liquid from the nozzle according to the driving of the piezoelectric element; a signal generation section configured to receive input of a residual vibration signal generated according to vibration remaining in the discharge section after the piezoelectric element is driven and generate a pseudo residual vibration signal corresponding to the residual vibration signal; a determination section configured to determine a state of the discharge section based on the pseudo residual vibration signal; and a switching section configured to switch whether to supply the residual vibration signal to the signal generation section.

According to the first aspect, it is possible to prevent the length of a unit period, which is a cycle for driving the discharge section, from increasing.

In a liquid discharge device according to a second aspect, which is a specific example of the first aspect, the switching section includes a first input terminal to which the residual vibration signal is input, a second input terminal to which constant potential is supplied, and an output terminal coupled to the signal generation section and switches, according to a switching signal, whether to make the first input terminal and the output terminal conductive or to make the second input terminal and the output terminal conductive.

According to the second aspect, distortion is prevented from occurring in the pseudo residual vibration signal generated by the signal generation section.

In a liquid discharge device according to a third aspect, which is a specific example of the second aspect, the signal generation section starts outputting the pseudo residual vibration signal after switching from a state of being coupled to the second input terminal via the output terminal to a state of being coupled to the first input terminal via the output terminal.

According to the third, it is possible to prevent the pseudo residual vibration signal in which distortion has occurred from being used for determining the state of the discharge section.

In a liquid discharge device according to a fourth aspect, which is a specific example of any one of the first to third aspects, the signal generation section includes: a low-pass filter; and a filter circuit configured to receive input of the residual vibration signal via the low-pass filter and generate the pseudo residual vibration signal.

According to the fourth aspect, the filter circuit can generate the pseudo residual vibration signal based on the residual vibration signal from which noise and the like are removed. As a result, according to the fourth aspect, it is possible to prevent distortion from occurring in the pseudo residual vibration signal.

In a liquid discharge device according to a fifth aspect, which is a specific example of any one of the first to fourth aspects, the determination section determines a viscosity increased state of the liquid in the discharge section based on the pseudo residual vibration signal.

According to the fifth aspect, it is possible to prevent a time required for the determination of the viscosity increased state of the liquid in the discharge section from increasing.

According to a sixth aspect, which is a preferred aspect, there is provided a liquid discharge head including: a discharge section including a nozzle, a piezoelectric element driven by a drive signal, and a pressure chamber configured to discharge liquid from the nozzle according to the driving of the piezoelectric element; a signal generation section configured to receive input of a residual vibration signal generated according to vibration remaining in the discharge section after the piezoelectric element is driven and generate a pseudo residual vibration signal corresponding to the residual vibration signal as a signal for determining a state of the discharge section; and a switching section configured to switch whether to supply the residual vibration signal to the signal generation section.

According to the sixth aspect, it is possible to obtain the same effects as the effects of the first aspect.

In a liquid discharge head according to a seventh aspect, which is a specific example of the sixth aspect, the switching section includes a first input terminal to which the residual vibration signal is input, a second input terminal to which constant potential is supplied, and an output terminal coupled to the signal generation section and switches, according to a switching signal, whether to make the first input terminal and the output terminal conductive or to make the second input terminal and the output terminal conductive.

According to the seventh aspect, it is possible to obtain the same effects as the effects of the second aspect.

In a liquid discharge head according to an eighth aspect, which is a specific example of the seventh aspect, the signal generation section starts outputting the pseudo residual vibration signal after switching from a state of being coupled to the second input terminal via the output terminal to a state of being coupled to the first input terminal via the output terminal.

According to the eighth aspect, it is possible to obtain the same effects as the effects of the third aspect.

In a liquid discharge head according to a ninth aspect, which is a specific example of any one of the sixth to eighth aspects, the signal generation section includes: a low-pass filter; and a filter circuit configured to receive input of the residual vibration signal via the low-pass filter and generate the pseudo residual vibration signal.

According to the ninth aspect, it is possible to obtain the same effects as the effects of the fourth aspect.

In a liquid discharge head according to a tenth aspect, which is a specific example of any one of the sixth to ninth aspects, the pseudo residual vibration signal is used to determine an viscosity increased state of the liquid in the discharge section.

According to the tenth aspect, it is possible to obtain the same effects as the effects of the fifth aspect.

What is claimed is:

1. A liquid discharge device comprising:
a drive signal generation section configured to generate a drive signal;
a discharge section including a nozzle, a piezoelectric element driven by the drive signal, and a pressure chamber configured to discharge liquid from the nozzle according to the driving of the piezoelectric element;
a signal generation section configured to receive input of a residual vibration signal generated according to vibration remaining in the discharge section after the piezoelectric element is driven and generate a pseudo residual vibration signal corresponding to the residual vibration signal;
a determination section configured to determine a state of the discharge section based on the pseudo residual vibration signal; and
a switching section configured to switch whether to supply the residual vibration signal to the signal generation section.

2. The liquid discharge device according to claim 1, wherein the switching section includes a first input terminal to which the residual vibration signal is input, a second input terminal to which constant potential is supplied, and an output terminal coupled to the signal generation section and switches, according to a switching signal, whether to make the first input terminal and the output terminal conductive or to make the second input terminal and the output terminal conductive.

3. The liquid discharge device according to claim 2, wherein the signal generation section starts outputting the pseudo residual vibration signal after switching from a state of being coupled to the second input terminal via the output terminal to a state of being coupled to the first input terminal via the output terminal.

4. The liquid discharge device according to claim 1, wherein the signal generation section includes:
a low-pass filter; and
a filter circuit configured to receive input of the residual vibration signal via the low-pass filter and generate the pseudo residual vibration signal.

5. The liquid discharge device according to claim 1, wherein the determination section determines a viscosity increased state of the liquid in the discharge section based on the pseudo residual vibration signal.

6. A liquid discharge head comprising:
a discharge section including a nozzle, a piezoelectric element driven by a drive signal, and a pressure chamber configured to discharge liquid from the nozzle according to the driving of the piezoelectric element;
a signal generation section configured to receive input of a residual vibration signal generated according to vibration remaining in the discharge section after the piezoelectric element is driven and generate a pseudo residual vibration signal corresponding to the residual vibration signal as a signal for determining a state of the discharge section; and
a switching section configured to switch whether to supply the residual vibration signal to the signal generation section.

7. The liquid discharge head according to claim 6, wherein the switching section includes a first input terminal to which the residual vibration signal is input, a second input terminal to which constant potential is supplied, and an output terminal coupled to the signal generation section and switches, according to a switching signal, whether to make the first input terminal and the output terminal conductive or to make the second input terminal and the output terminal conductive.

8. The liquid discharge head according to claim 7, wherein the signal generation section starts outputting the pseudo residual vibration signal after switching from a state of being coupled to the second input terminal via the output terminal to a state of being coupled to the first input terminal via the output terminal.

9. The liquid discharge head according to claim 6, wherein the signal generation section includes:
a low-pass filter; and
a filter circuit configured to receive input of the residual vibration signal via the low-pass filter and generate the pseudo residual vibration signal.

10. The liquid discharge head according to claim 6, wherein the pseudo residual vibration signal is used to determine an viscosity increased state of the liquid in the discharge section.
